(19) United States
(12) Patent Application Publication
(10) Pub. No.: US 2026/0105108 A1
(43) Pub. Date: Apr. 16, 2026

(54) SCHEMA-GUIDED WEBPAGE CONTENT VARIATION USING MACHINE LEARNING

(71) Applicant: Webflow, Inc., San Francisco, CA (US)

(72) Inventors: Jin Lim, Cupertino, CA (US); Wuyang Dai, Menlo Park, CA (US); Brian Webb, Los Gatos, CA (US); Jason Kahn, Washington, DC (US); Guy Yalif, Burlingame, CA (US); Justin Helmer, San Mateo, CA (US)

(21) Appl. No.: 19/357,876

(22) Filed: Oct. 14, 2025

Related U.S. Application Data
(60) Provisional application No. 63/707,167, filed on Oct. 14, 2024.
(60) Provisional application No. 63/707,158, filed on Oct. 14, 2024.

(51) Int. Cl. G06F 16/9532; G06F 16/9538

(52) U.S. Cl. CPC G06F 16/9532; G06F 16/9538

(57) ABSTRACT

Methods, systems, and apparatus, including computer programs encoded on computer storage media, for generating webpage data. An example method includes accessing content data associated with a first webpage and determining context data corresponding to one or more users associated with the first webpage. Based on (i) the content data and (ii) the context data, prompt data for one or more trained machine learning (ML) models is generated. The prompt data is provided to the ML models to obtain output data corresponding to one or more variation content elements. Data representing one or more candidate webpages is generated by adapting the one or more variation content elements according to the content schema. An instruction is provided to a computing device to cause the display of a representation of at least one candidate webpage included in the one or more candidate webpages.

### CROSS-REFERENCE TO RELATED APPLICATIONS

This application claims the benefit of U.S. Provisional Application Nos. 63/707,158 and 63/707,167, each filed on Oct. 14, 2024, the contents of which are incorporated by reference in their entirety.

### TECHNICAL FIELD

This disclosure generally describes technology relating to machine learning, and more particularly, to technology related to the integration of machine learning to cloud-based software platforms.

### BACKGROUND

Machine learning (ML) enables systems to learn from data and improve their performance without being explicitly programmed for every task. Rather than following predefined rules, ML systems build models based on patterns found in large datasets. These models may make predictions, classify data, or perform decision-making tasks based on new, unseen data. ML may involve providing input data into a trained model, which processes the provided data to identify patterns or relationships within the data.

ML may involve several types of learning. For example, in supervised learning, a model is trained on labeled data, where both the inputs and desired outputs are known. The goal is to learn a mapping from inputs to outputs to make predictions on new, unlabeled data. As another example, in unsupervised learning, a model works with data that has no labeled outcomes. Another example is reinforcement learning, where a model learns by interacting with an environment and receiving feedback in the form of rewards or penalties. ML has applications across industries, including healthcare, finance, and consumer-focused technologies. In the context of healthcare, ML systems and techniques may be useful to predict diseases, analyze medical images, and provide other advantages.

Information retrieval systems typically receive a user query and match the query against an index constructed from a corpus of documents. The index may be created by parsing documents, extracting terms and features, and building data structures that map terms to document locations. Candidate results are identified using lexical signals such as term frequency, inverse document frequency, and field weighting, and are ranked by relevance scores. ML may be used to automate and improve these stages, including query understanding, document representation, candidate generation, and ranking.

### SUMMARY

This disclosure relates to systems and techniques that use ML-generated content to streamline and accelerate the creation of webpage variations (e.g., for personalization, prototyping, testing) in complex, schema-driven production environments. The systems access content data from a content management system (CMS) according to a predefined content schema. The schema establishes the relationships and constraints of content elements and is used as a foundational blueprint for the automated generation of prompt data for ML models (e.g., multimodal models capable of producing variations of text, HTML, and images). By grounding the content generation process in the CMS content structure, the resulting ML-generated content is compatible with the target environment, improving the functioning of CMS compute elements by reducing or eliminating integration bugs and ensuring that multiple landing page variations may be deployed directly and safely into a live production setting to optimize user engagement and conversion rates.

The systems and techniques further enhance user productivity and reduce the learning curve associated with complex web design tools. This may be achieved by generating multiple candidate webpages, either for user selection or testing, based on a webpage schema and ML techniques. Each candidate webpage differs from the others by one or more variable content elements or items. Those variable content elements are either generated using ML models or retrieved from a database. The webpage schema enables efficient arrangement of various webpage components to form new webpages, where the webpage schema enables the efficient arrangement of these components by ensuring each is correctly linked to its respective variation content element.

For example, a system may access content data associated with a current webpage. This content data includes multiple content elements organized within corresponding webpage components. Such data may be stored in a CMS and displayed on a controller device (also referred to as a computing device below) according to a predefined content schema. The content schema allows the system to access, retrieve, and modify these elements efficiently within the CMS.

As defined herein, the term “content schema” refers to a structured definition that specifies the organization, attributes, and relationships of content items within the system. A content schema may define one or more fields, each associated with a data type (e.g., text, integer, media, or relational reference), a set of constraints (e.g., required, optional, uniqueness), and optionally, hyperlinks connecting content items to other items, schemas, or data sources. In short, the content schema serves as a blueprint governing how content data is stored, linked, validated, and retrieved by the system.

In some implementations, the system includes a webpage scraper engine configured to read content items in the current webpage and the corresponding content schema in real time. The scraper may categorize content items (e.g., headings, body text, hyperlinks, media) based on their semantic meaning and, optionally, their semantic hierarchy. Using these classifications, the scraper may generate summaries or vectorized feature representations that capture the overall theme, tone, or style of the content presented on the webpage. The system may process these summaries to derive one or more constraints, e.g., brand guidelines, stylistic parameters, or keyword boundaries, for generating variation content items used to instantiate multiple candidate webpages.

The system may be further configured to determine context data associated with a user designing or editing the current webpage on a computing device. The context data may further include historical user data and other relevant data stored within the system's multi-tenant database. For example, historical data may encompass the user's prior design actions, previously generated webpages, or user-specified metadata related to brand preferences and content structure. The context data may also incorporate expert insights pertaining to webpage components, such as recommendations on typography, tone, accessibility, or conversion optimization. Additionally, the context data may include user request data specifying content generation requirements to generate content for the population of webpage components according to the predefined content schema (or a generalized schema for the webpage). The user request data may further define parameters such as target audience, content goals, layout preferences, stylistic constraints, or other suitable parameters, thereby providing a comprehensive set of inputs to guide the content generation process.

In some implementations, prompt data is generated based on the content data of the current webpage and the associated context data. The prompt data may serve as input to one or more machine learning (ML) models for generating variation content items. In particular, the prompt data may include one or more instructions that guide the ML models to generate variation content elements derived at least in part from the content elements presented on the current webpage. The ML models may include, for example, a multimodal ML model, a Large Language Model (LLM), or other suitable generative or discriminative models capable of producing a diverse range of outputs, including textual, visual, audio, or other suitable multimedia types.

The system may provide the prompt data to the ML models and receive, in response, ML-generated outputs corresponding to one or more variation content elements. These variation content elements may represent alternative versions of text, images, layout, or interactive components designed to align with predefined design principles, brand guidelines, or user-specified objectives.

Using the variation content elements, the system may generate candidate webpage data by adapting the variation content elements into their respective positions within the webpage layout or into corresponding webpage components, as defined by the predefined content schema. The system may also transmit an instruction to a computing device such that, upon execution, the computing device displays a representation of one or more of the candidate webpages for the user's preview, testing, or selection.

In some implementations, the system receives subsequent user requests to modify, regenerate, select, or deselect one or more generated content items and/or webpage components (or sections) of the webpage. A subsequent user request may specify that one or more existing content items on the current webpage be replaced with variation content items or newly generated content. In response, the system may instantiate a new webpage including a different combination of variation content items, webpage components, or both. In certain implementations, the system may further cause the ML models to generate additional or updated content to populate the specific webpage components or sections identified in the subsequent user request.

The system may also receive user input data indicating a selection of a particular candidate webpage from among the plurality of generated candidate webpages. In response to the user's selection, the system may update or adjust the configuration associated with the selected candidate webpage within the CMS based on the variation content elements included in that webpage. The CMS may maintain the schemas and associated data of other webpages unchanged, ensuring stability and isolation between webpage versions and facilitating tracing of historical webpage versions.

The system may receive user feedback data derived from user interactions with the displayed content on the computing device. The system may analyze this feedback data, such as engagement metrics, click patterns, qualitative evaluations, or other suitable feedback data, and incorporate the results into subsequent content generation processes. This feedback-driven refinement allows the system to iteratively improve the quality, relevance, and performance of variation content items and webpage components.

The term “schema” generally refers to a structured definition that specifies how respective content elements, such as text, images, media, or metadata, are organized, related, and retrieved within the CMS. A schema defines relationships between webpage components, field types, and data hierarchies, ensuring consistent and efficient data access across multiple webpages.

The term “webpage components” generally refers to various configurable and interrelated component units that represent the hierarchical and visual structure of a webpage. In other words, webpage components may refer to various elements, modules, or sections that collectively form a webpage, as well as any combination thereof. For example, a webpage component may correspond to a section, subsection, or other structural unit within the webpage. Each section may include one or more constituent elements, such as a title, a body of text, a biography, an image, or other relevant information suitable for the design or purpose of the webpage.

The term “context data” generally refers to background or supplemental information associated with user request data. More specifically, the context data may include various types of contextual information, such as workspace context corresponding to the current webpage and content items being edited by the user, metadata associated with the webpage components (e.g., schema, or section-level metadata for components identified in the user request, also referred to as “section metadata” below), metadata derived from user-specific historical or preference data stored within a respective domain of a multi-tenant database, expert insights and recommendations on typography, tone, accessibility, or conversion optimization, or other suitable contextual information associated with the user request data.

For example, context data may specify a workspace context describing the state of an application at or around the time a user submits a query. The workspace context may identify this state by specifying various types of information, such as the active page or route, an element or component selection, a component hierarchy snapshot, currently visible panels and settings, responsive breakpoints, recent authoring actions, a project-type label indicating the class of site being developed, among others. The workspace context may further include user-specific attributes such as a role or skill tier determined from historical interactions to tailor the level of detail in responses. Context data may further be obtained from a client-side software development kit (SDK), from server-side session state, or from both. In privacy-aware deployments, the collection process may redact user content while retaining structural identifiers sufficient for retrieval and answer construction.

The term “section metadata” generally refers to data that defines the structure and organization of a webpage by specifying its sections and their respective functions. For example, section metadata may specify that a webpage includes a header section with a title and one or more navigation links, a body section containing text and one or more images, a price section presenting multiple pricing options, a testimonial section highlighting user feedback, a footer section with contact information and legal disclaimers, an about section briefly summarizing information associated with the webpage, a FAQ section including answers to a list of frequently asked questions, a contact section that summarizes various contact methods associated with the webpage, etc. Section metadata may also define formatting attributes, such as whether a section supports rich media (e.g., embedded video) or dynamic content (e.g., user comments). Section metadata may further include other suitable data specifying the formatting, arrangement, or combination of potential content chunks in the CMS that constitute a candidate webpage.

Section metadata may be updated and/or inferred from a user's historical behavior or historical data stored in a multi-tenant database for the user. For example, if a user frequently builds event registration pages that include a countdown timer, an agenda section, and a speaker bio section, the system may learn this preference and automatically prioritize similar section arrangements in future webpage generations. This approach personalizes the generation process, reduces repetitive manual input, and aligns the generated webpages with the user's established design patterns.

The term “semantic hierarchy” generally refers to an ordered structure that defines semantic relationships among content elements of one or more webpage components in a webpage, across multiple webpage components of the webpage, or other suitable relationships or links in the webpage, based on their respective semantic meaning, context, and level of abstraction. In some implementations, the semantic hierarchy is explicitly defined within context data (such as section metadata) or derived dynamically from user request data by the system. The hierarchy establishes how information is conceptually organized (e.g., identifying which elements represent higher-level summaries, categories, or topics) and which elements provide supporting details, explanations, or examples.

In some implementations, the semantic hierarchy describes parent-child or peer-to-peer relationships between webpage components and their corresponding content. For instance, a higher-level section may semantically encompass several subordinate subsections that elaborate on distinct aspects of the same or related concept, while individual content items within those subsections may further refine or illustrate high-level topics for those subsections. The semantic hierarchy may also express semantic dependencies between textual and non-textual elements (e.g., between a title and an associated image caption or between a summary paragraph and detailed lists). By infusing these semantic relationships into content generation using ML models, the system may generate content that maintains conceptual and logical coherence across the entire webpage.

The systems and techniques described herein provide technical advantages by enabling the efficient and automated generation of multiple candidate webpages that include varied content elements for corresponding webpage components, based on user request data and associated context data. Each candidate webpage may be rapidly populated by substituting variation content items into one or more designated webpage components, rearranging component layouts in the webpage, or both. This modularized generation framework allows the system to rely on webpage schemas and component definitions, which significantly reduces computational overhead. The rapid generation of multiple webpage candidates further enables real-time experimentation, user testing, and verification of webpage designs, which accelerates content creation workflows and improves overall design productivity.

The systems and techniques may also support iterative modification and optimization of a webpage through user interactions. A user may submit subsequent modification requests via an interactive user interface on a controller device. The subsequent modifications prompt the system to regenerate, modify, or replace specific content items, adjust webpage components, or apply alternative design layouts. The system may also process feedback data received from user interactions, such as content approval or selection, a change in metrics or parameters, engagement scores, or other suitable evaluative signals. The system may incorporate these results into the backend generation pipeline. Through this adaptive feedback loop, the system may continuously update prompt data for content generation, update content data stored in the CMS, or both to refine the accuracy, relevance, and efficiency of webpage generation in response to evolving user preferences and design objectives.

The systems may also be configured to ground ML-based content generation using structured user request data and contextual metadata to improve the precision and relevance of generated content. The context data may include user requirement data (e.g., style, tone, or target audience preferences), user history data (e.g., prior design actions or stored templates), and expert insight data (e.g., content heuristics or best-practice guidelines). By incorporating this contextual grounding, the ML models may generate contextually consistent and stylistically coherent content across webpage components. The ML models may include multimodal models, LLMs, or other generative architectures. The content types encompass a diverse range of modalities, including text, image, audio, and other multimedia elements. The multimodal nature of the ML models enhances the robustness of content generation and optimization, enabling the system to satisfy a wide range of content generation requirements while maintaining semantic and visual consistency across webpage components.

Additionally, the system may efficiently update content data stored within the content management system (CMS) based on a user's selection of a candidate webpage. Specifically, the system modifies only the relevant content data and corresponding component mappings in accordance with the predefined content schema. The system generally leaves unrelated or unselected webpage data (e.g., content items and corresponding webpage components) intact. This selective update process reduces memory usage, minimizes unnecessary data processing, and conserves computing resources. Moreover, the schema-driven update mechanism facilitates version tracking, rollback operations, and efficient synchronization between webpage variants. This mechanism accordingly improves the reliability, maintainability, and scalability of the CMS and the content/webpage generation.

In one general aspect, this disclosure is focused on a computer-implemented method that includes a set of operations. The operations include accessing, by a server system and from a computing device, content data associated with a first webpage. The content data includes a plurality of content elements and is accessed from a content management system according to a predefined content schema defining relationships between the plurality of content elements. The operations further identify, by the server system, context data corresponding to one or more users associated with the first webpage. Additional operations include generating, by the server system and based on the content data and the context data, prompt data for one or more trained machine learning (ML) models. The prompt data includes one or more instructions for generating one or more variation content elements based on the plurality of content elements. The operations also include providing, by the server system, the prompt data to the one or more trained ML models, and obtaining, by the server system and from the one or more trained ML models, output data corresponding to the one or more variation content elements. The operations further include generating, by the server system, data representing the one or more candidate webpages by adapting the one or more variation content elements according to the predefined content schema. The operations also include providing, by the server system and to the computing device, an instruction that, when received by the computing device, causes the computing device to display a representation of at least one candidate webpage included in the one or more candidate webpages.

In some implementations, the context data may include one or more of user requirement data, user history data, or expert insight data.

In some implementations, the user requirement data may include a textual input by a user of the computing device into an application displayed on the first webpage.

In some implementations, the plurality of content elements may include textual content at respective abstraction levels of the first webpage, visual content of the first webpage, and one or more hyperlinks associated with the textual content or the visual content.

In some implementations, generating data representing the one or more candidate webpages may include replacing a content element specified in the first webpage with a corresponding variation content element.

In some implementations, the one or more trained ML models may include a multi-modal ML model.

In some implementations, the one or more trained ML models may include a large language model (LLM).

In some implementations, the operations may further include receiving, by the server system and from the computing device, user input data indicating selection of a particular candidate webpage from among the one or more candidate webpages; and in response to receiving the user input data, adjusting a configuration associated with the candidate webpage within the content management system based on one or more variation content elements corresponding to the particular candidate webpage.

In some implementations, the operations may further include receiving, by the server system, data indicating a user modification to the representation of the at least one candidate webpage. The operations also include generating, by the server system and based on the user modification, second prompt data for the one or more trained ML models. The second prompt data may include one or more instructions for generating one or more additional variation content elements based on the user modification. The operations further include providing, by the server system, the second prompt data to the one or more trained ML models, and obtaining, by the server system and from the one or more trained ML models, second output data corresponding to one or more additional variation content elements. Additional operations include generating, by the server system, data representing one or more updated candidate webpages by adapting the one or more additional variation content elements according to the predefined content schema. The operations also include providing, by the server system and to the computing device, a second instruction that, when received by the computing device, causes the computing device to display a second representation of at least one of the one or more updated candidate webpages.

The details of one or more implementations of the disclosure are set forth in the accompanying drawings and the description below. Other features, objects, and advantages of the invention will be apparent from the description and drawings, and from the claims.

### BRIEF DESCRIPTION OF DRAWINGS

FIG. 1 illustrates an example of a technique for generating candidate webpages in response to a user request using one or more ML models and a content management system.

FIG. 2 illustrates an example of a system that enables a web experience platform (WEP) for supporting web development using one or more ML models.

FIGS. 3A-3D illustrate a sequence of examples of user interfaces for generating candidate webpages in response to a user request using one or more machine learning models and a content management system.

FIG. 4 illustrates an example of a process for generating content data using one or more ML models.

FIG. 5 illustrates a flow chart for an example of a process for generating candidate webpages in response to a user request using one or more ML models and a content management system.

In the drawings, like reference numbers represent corresponding parts throughout.

### DETAILED DESCRIPTION

This disclosure is focused on computer-implemented technology that improves the integration of ML into production environments by leveraging schema requirements specified within a CMS in generating multiple variations of a webpage. These schema requirements are used to construct constrained and context-aware prompts that ensure the resulting ML-generated content is compatible with the CMS. For example, a system may be configured to receive user request data from a computing device that specifies a user's instructions for generating one or more candidate webpages. The request data may also identify a subset of webpage components for which content is to be generated, such as one or more sections, subsections, titles for sections or subsections, or corresponding bodies of text associated with those elements.

When generating variation content elements, the backend process described below may inherit the same schema and corresponding memory addresses as the original content for direct substitution or allocate new memory addresses for parallel storage. This flexible addressing scheme enables fast retrieval, caching, and population of variation content elements into designated webpage components, thereby accelerating webpage generation and reducing latency.

Variation content elements may be generated using one or more ML models based on prompt data that is contextually grounded in both the context data and the content data of the current webpage. The context data of the current webpage may include user requirement data specified in a user request (e.g., design preferences, tone, or layout constraints), user history data (e.g., prior design actions or engagement analytics), expert insight data (e.g., content heuristics, marketing best practices, or accessibility standards), workspace context, section metadata, or other suitable context data.

ML models may process diverse forms or types of prompt data and generate multimodal outputs, including text, images, audio, or other suitable multimedia content elements. For instance, the ML subsystem may include multimodal encoders and decoders, LLMs, diffusion-based generators, or other suitable ML architectures. These models may operate collaboratively, where encoders extract semantic representations of the prompt data and decoders synthesize variation content elements consistent with the extracted semantic representations.

The disclosed techniques further enable iterative content and design refinement by allowing users to request updated content items or webpage components on an ongoing basis. This iterative loop facilitates rapid prototyping, A/B testing, and conceptual experimentation in webpage development. The system may access, store, and modify both original and variation content elements within the CMS using the schema associated with each candidate webpage and/or the content schema associated with individual content items. By maintaining schema-level mappings between generated content and webpage components in the CMS, the system preserves logical relationships across webpage versions, ensuring that iterative updates remain consistent and reversible.

The CMS may also perform semantic retrieval of content data by leveraging vector-based similarity metrics. For example, the system may determine a semantic similarity score between vector features of context data (such as user requests, design goals, or style parameters, as described above) and vector representations of existing content items (or content chunks, and/or webpage components) stored in the CMS. By ranking and retrieving the most semantically aligned data, the system may accelerate webpage assembly and enhance personalization accuracy. This semantic retrieval mechanism enables adaptive reuse of previously generated or stored content data, reducing redundant generation and improving system efficiency in both computation and storage. It also enables the CMS to serve as a dynamic knowledge base that evolves in response to user interactions and design trends.

In some implementations, the system sends instruction data to a computing device to display previews of one or more newly generated candidate webpages populated with content data either retrieved from the CMS or obtained from ML models. The user of the computing device is enabled to preview and confirm the generated content elements (and optionally the candidate page). Through an interactive user interface, users may provide feedback data by selecting, deselecting, editing, or otherwise modifying specific content elements or webpage components. Additionally (or additionally), users may issue subsequent requests to replace or regenerate content across multiple webpage components.

The system may further analyze user feedback data and incorporate the analyzed results into subsequent content generation processes. The user feedback data includes user engagement metrics, click patterns, cursor movements, time-on-element statistics, qualitative assessments, or other suitable feedback data. By learning from user feedback, the system continuously refines the content generation process (e.g., refining prompt data for ML models). This improves the contextual accuracy, stylistic alignment, and overall quality of future webpage and content elements generation and further enables the system to evolve dynamically with user preferences and design trends.

The systems and techniques also improve various aspects of webpage development, such as creating content for webpages within an authoring environment using ML. Generally, the user may interact with a software application on their client device that allows users to create, publish, and modify digital content without any coding experience. Users interact with this software application to manage websites, manage website content, and generate new website content regardless of technical expertise or skill level. The software application may provide a graphical user interface (GUI) on the client device that enables the user to create, edit, modify, and publish webpage content online.

The systems and techniques described herein also improve upon contextual guidance provided by code generation systems. For instance, instead of merely retrieving information from a fixed knowledge base to guide a user's manual actions, the present disclosure describes a system that automates the generation of content according to a semantic hierarchy specified or inherent in the user request data. While some code generation systems utilize a passive knowledge base for informational retrieval, the systems leverage the CMS as an active, executable framework. This is achieved by constructing a prompt for an ML model that is specifically constrained by a set of web development tools and tasks that are native to the CMS. The system's awareness of the available tools, their development history, prior usage patterns, and the multi-tenant architecture of the platform allows it to generate a highly specific set of instructions for the ML model, moving beyond informational guidance to automated action.

The systems and techniques also leverage prompt construction techniques distinct from some code-generation platforms or “design-to-code” platforms, which typically generate code artifacts (e.g., HTML, CSS) in a relatively unconstrained context. Such platforms often lack deep awareness of the complex rules, schema, and historical context of a specific, pre-existing production environment, such as a multi-tenant CMS. In contrast, the prompt construction processes described herein are uniquely informed by a confluence of data sources. This includes the user's current visual context (e.g., a portion of the webpage the user is viewing and interacting with) and the current, pre-modification state and configuration of the specific webpage. The data sources also include the architectural and historical constraints of the underlying CMS, including the specific web development tools and tasks available to a particular user account and compatible with the target webpage. This multi-contextual awareness enables a high degree of automation within a complex environment, ensuring that the ML-generated code update segment is not only responsive to the user's natural language request but is also guaranteed to be compatible, executable, and consistent with the production environment, thereby avoiding the risks associated with deploying code generated in an isolated context.

The information retrieval techniques disclosed herein, utilizing CMS and schema, are directed at addressing problems that are uniquely encountered in computer-related technology. As described herein, the techniques improve how networked computing systems retrieve and serve information under accuracy and latency constraints using specialized data structures and machine operations. This operates on machine-generated signals (e.g., workspace context captured from application state, content chunks with up-to-date metadata, high-dimensional vector representations stored in one or more vector databases) and applies computer-implemented processes (e.g., semantic similarity search, query expansion, prompt assembly) that condition ML models on retrieved passages and section metadata. These steps improve the functioning of the computer by reducing off-topic results, enforcing recency via CMS-managed updates, and meeting a defined end-to-end time threshold from query receipt to UI display. Manual analogs of these operations result in a fundamentally different process.

For instance, a person cannot observe and identify context data for webpage generation (e.g., workspace context, historical context, or other context data) within a specified time period (e.g., less than three seconds), compute nearest neighbors over multimodal embeddings, or orchestrate model routing and caching to satisfy timing lrequests for imitations associated with the distributed services. The operations involved in the disclosed information retrieval techniques disclosed herein, therefore, address problems unique to computerized information retrieval (context loss, staleness, and scale) and constitute a specific improvement in the operation of computer systems.

Moreover, the information retrieval techniques disclosed herein involve elements specific to computer-related technology, such as vector databases and RAG, to generate information outputs. A vector database transforms heterogeneous source content into machine-optimized representations that enable sub-second retrieval for prompt construction and retrieval-augmented generation. Raw documents may be segmented into content chunks and passed through an embedding model that maps each chunk into a high-dimensional numeric vector whose coordinates encode semantic relationships. The database persists these vectors in specialized indexes, such as graph-or quantization-based nearest-neighbor structures with cache-aligned layouts, precomputed centroids, and distance metrics. A refined query may be embedded once and matched against millions of candidates in time budgets suitable for interactive use. Each stored vector is keyed to a source passage, up-to-date metadata, and version identifiers so the retriever may return current and authoritative chunks that may be injected into an ML prompt without additional parsing.

Data transformations involved in generating embeddings for storage in a vector database make them distinct from mental steps used by humans in storing information. Embeddings are opaque numeric arrays, and similarity search requires parallel numeric kernels over high-dimensional spaces, and the ranking policies that trade recall for latency depend on index statistics and hardware locality. Accordingly, the transformed format of embeddings and their retrieval from a vector database using RAG represent a computer-specific optimization that enables the disclosed information retrieval techniques to supply relevant context to ML models at speeds no manual process could achieve (e.g., within three seconds).

As described herein, “machine learning” refers to a class of computational techniques and models, including to neural networks, transformer-based architectures, generative artificial intelligence, decision trees, support vector machines, clustering algorithms, and statistical learning methods. These techniques and models enable a computer system to automatically learn patterns or representations from data and improve performance on a given task without being explicitly programmed with task-specific rules. ML systems may operate in supervised, unsupervised, semi-supervised, reinforcement, or self-supervised learning paradigms, and may be designed to perform a wide range of tasks such as classification, prediction, generation, translation, anomaly detection, and optimization across various data modalities, including text, images, audio, video, and structured data.

As described herein, a “model” refers to a computational system, algorithm, or structured representation used with a ML system. Examples of models include ML models, neural networks, transformer-based architectures, generative models, reasoning models, agentic systems, probabilistic models, statistical models, or rule-based systems. Models may be designed to process input data and produce outputs, predictions, decisions, actions, representations, or generated content. Models may operate under various learning paradigms, including supervised, unsupervised, semi-supervised, reinforcement, or self-supervised learning, and may be configured to perform tasks such as classification, regression, recommendation, anomaly detection, generation, translation, summarization, planning, decision-making, or multi-step reasoning across a range of data modalities, including structured data, text, images, audio, video, and sensor data.

As described herein, a “tool” refers to a discrete, callable unit of functionality that is registered within a platform registry and made accessible to one or more subsystems of an application. A tool may encapsulate a particular software capability, module, or feature, and may be invoked directly by a user or indirectly by an orchestration engine, assistant subsystem, or agentic process. A tool may be defined by a metadata specification that describes its functional purpose, input parameters, output types, and access constraints. Such metadata may further include contextual invocation rules or skill-gating requirements that limit tool execution based on user roles, system state, or external conditions. A tool may also be executed within the host application or may trigger remote services, APIs, or external modules. For example, a tool may perform data transformation, retrieve content from a content management system, initiate ML inference, or apply an automation feature to a digital asset. Tools may be atomic (e.g., performing a single function) or composite (e.g., orchestrating multiple underlying functions).

As described herein, a “module” generally refers to a discrete, encapsulated software unit that implements a defined subset of functionality within a larger system. For example, a module may include executable code, data structures, and associated interfaces that collectively enable the module to perform one or more tasks, operations, or services. In some implementations, a module exposes an API or inter-process communication interfaces through which other system components (e.g., agents, tools, or orchestration engines) may invoke module functionality. The module may be configured for local execution within an application runtime or for remote execution via a distributed service environment.

As described herein, a “collection” generally refers to a structured data container defined within a content management system. A collection may include one or more fields specifying attribute types and constraints, where each field is configured to store content of a designated type (e.g., text, image, reference, or relational identifier). The collection may further define a schema for a class of content items and may be programmatically bound to presentation templates for automatic instantiation of one or more web pages or components.

As described herein, a “component” generally refers to a reusable design element or grouping of design elements within a visual design environment. A component may include structural markup (e.g., containers, text elements, media placeholders), style definitions (e.g., Cascading Style Sheets (CSS) class associations), and behavioral attributes (e.g., event listeners, animations). Components may be instantiated multiple times across different pages, with instances linked to a common definition such that modifications to the component definition propagate to each instance.

As described herein, a “schema” generally refers to a structured definition that specifies the organization, attributes, and relationships of data within a system. A schema may define one or more fields, each field associated with a data type (e.g., text, integer, media, or relational reference), a set of constraints (e.g., required, optional, uniqueness), and optionally a link to other schemas or data sources. The schema operates as a blueprint governing how data is stored, validated, and retrieved by the system. A schema may be represented in a machine-readable format (e.g., JavaScript Object Notation (JSON), Extensible Markup Language (XML), proprietary markup), enabling programmatic generation of data containers and enforcement of structural consistency across instances. At runtime, the system may validate input data against the schema to ensure compliance and may utilize the schema to automatically bind data values to corresponding fields or locations of a webpage.

As used herein, a “template” generally refers to a parameterized layout structure defining a presentation format for one or more data-driven pages. A template includes a set of design elements, placeholders, and binding definitions linking fields of a collection to corresponding elements of the layout. Upon execution of a publishing or rendering process, the template is programmatically combined with data from one or more collection items to generate fully populated output pages or views.

As used herein, “interactions” generally refer to declarative animation and behavior specifications that define dynamic changes to one or more elements of a rendered page in response to runtime events. An interaction may include a trigger definition identifying the initiating event, a set of target elements, and one or more animation or state-change operations to be applied to the target elements according to defined timing or sequencing parameters.

As used herein, a “trigger” generally refers to an event condition that initiates execution of an associated interaction or workflow. Triggers may include user-interface events (e.g., click, hover, scroll, page load) or system-generated events (e.g., content update, data submission). A trigger definition may specify the scope of the monitored condition and, upon detection of such condition, causes initiation of the corresponding action sequence.

As used herein, “logic” refers to a declarative workflow specification defining automated operations to be executed in response to system or user events. Logic may be represented as a sequence of interconnected nodes or steps, where each step specifies an action (e.g., data manipulation, API request, content update) and may include conditional branching, variable mapping, or external service integration. Logic is evaluated and executed by a backend workflow engine in response to event detection.

As described herein, an “agent” (or “ML agent”) generally refers to a software entity configured to operate autonomously or semi-autonomously within a computing environment by perceiving context, evaluating state, and executing one or more actions on behalf of a user or system. Agents may incorporate ML models (LLMs, large action models (LAMs)), or other ML-based subsystems that enable adaptive behavior, natural language processing, decision-making, and dynamic invocation of system functionality.

Further, an “agentic” process or behavior generally refers to the autonomous or context-driven execution of actions by an agent, without requiring explicit step-by-step instructions from a user. For example, agentic functionality may include interpreting natural language or multimodal prompts based on processing input queries submitted by a user. In other examples, agentic functionality includes determining relevant goals or sub-tasks, invoking software capabilities (e.g., tools, functions, external services registered) within a platform registry, and sequencing or chaining such invocations until an objective is satisfied.

As discussed in detail below, the ML techniques disclosed herein may be provided to augment, streamline, and/or improve various aspects of a web experience platform that allows users to perform various types of actions relating to website development (e.g., access, design, develop, build, access, manage, analyze). Through ML, the techniques disclosed herein may allow users to generate website or webpage content that conforms to structure and schema of a designated webpage. For example, in a ML-enabled web experience platform, when a user requests changes or modifications to components of a webpage, the ML may be configured to create new text, images, and other relevant content based on the user text, prompt, selection, or other input provided by the client device.

Implementations of the present disclosure are described in further detail herein with reference to the creation of content for webpages. In some implementations, the techniques described in this present disclosure are applicable to the creation of content for other applications, such as apps, emails, product designs, brochures, or other products, to name some examples.

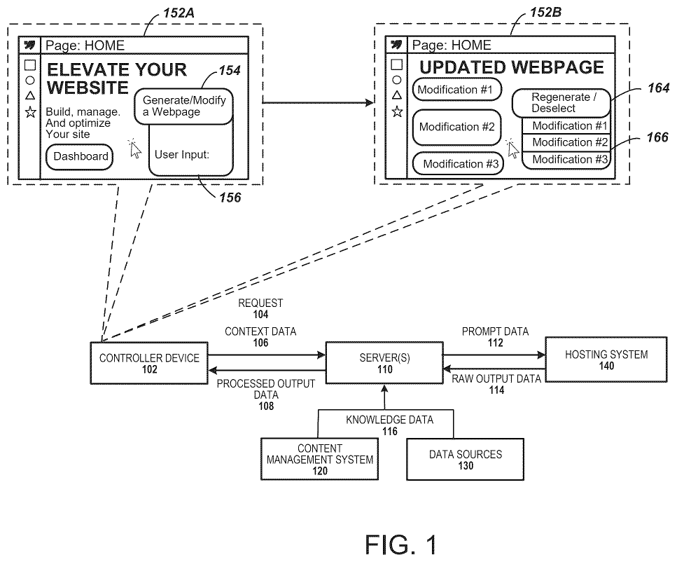

FIG. 1 illustrates an example of a technique for generating candidate webpages in response to a user request using one or more ML models 142 and a content management system 120. In the example shown in FIG. 1, the controller device 102 may display a home page, a starting page, or an application 152A for a controller or a user of the controller device 102. The application 152A includes a user interface (UI) 154, e.g., a text-based chat interface or hybrid input panel, that enables the user to enter requirements (e.g., request data 104) in an input box 156 for generating multiple webpages by generating new webpage content, updating existing webpage components, and/or modifying structural arrangements of a webpage. In some implementations, the user interface 154 further provides inline suggestions, tooltips, or contextual guidance on how to phrase or format a request for webpage generation or modification. For example, the user interface 154 may include an ML-based application to provide additional guidance for the user to generate webpage variations in bulk.

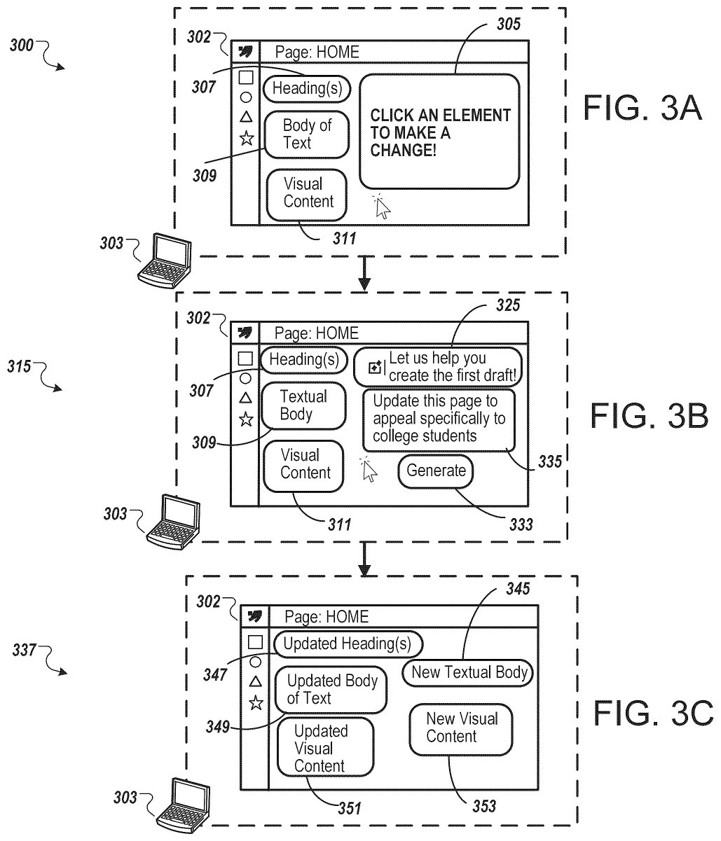

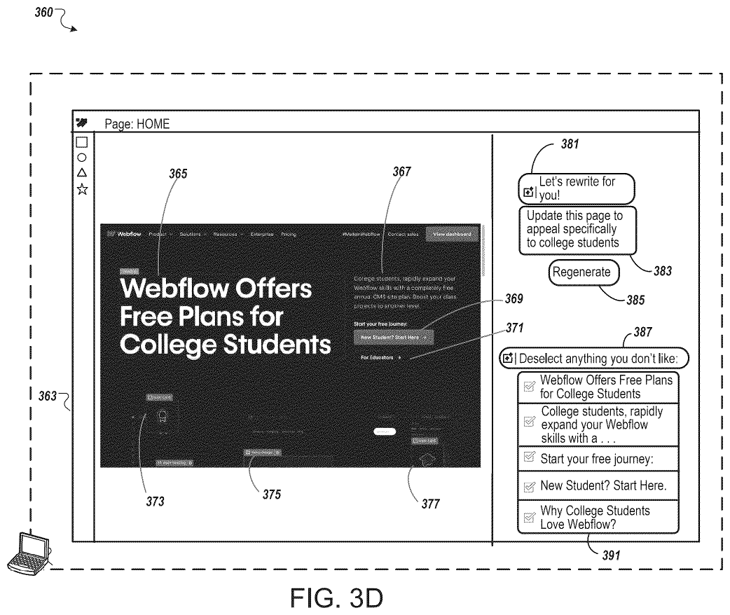

This open-ended, chatbot-style interface 145 allows users to express their design intent, stylistic preferences, or structural requirements in natural language, without requiring manual configuration of webpage templates or component hierarchies. The system interprets these inputs, transforms them into structured requirement data, and prepares them for downstream processing by ML models and CMS operations. Additional examples and configurations of the user interface 154 are described below with reference to FIGS. 3A-3D.

After the user finishes entering the requirements for generating content or webpages in the input box 156, or through other interactive elements within the application 152A, the user may activate one or more user interface controls to transmit the requirement data to the server(s) 110. This transmission may occur, for example, when the user clicks a submission button, presses the “Enter” key, or issues a voice command, depending on the configuration of the controller device 102.

Upon receiving the user request entered through the input box 156, the system processes the user request data 104 in the backend using one or more machine learning (ML) models 142 in conjunction with the content management system (CMS) 120. In some implementations, the system additionally processes context data 106, which further includes historical data, user preference data, expert insight data, or other relevant metadata that complements the user request data 104.

During backend processing, the system may construct prompt data for the ML models. The prompt data is grounded in the processed context data 106 to ensure that the generated output remains relevant, coherent, and contextually consistent. The backend process may further include accessing content data stored in the CMS 120 through a predefined content schema associated with the target webpage. The content schema defines relationships between webpage components and their corresponding content items, enabling the system to integrate generated variation content elements seamlessly into the appropriate webpage components of multiple candidate webpages.

Depending on the complexity of the models, the volume of input data, and the current network or server load, this backend computation process may range from several seconds to a few minutes. Once complete, the system may transmit the generated results back to the controller device 102 for rendering, preview, and further user interaction.

Once backend processing is complete, the controller device 102 receives instructions that, when executed, cause the controller device 102 to display an updated representation 152B of the application 152A. The updated interface 152B presents multiple candidate webpages, each populated with variation content elements generated by the system and organized within the designated webpage components. These candidate webpages are displayed for the user's review, modification, and confirmation. This dynamic feedback loop enables users to efficiently evaluate alternative webpage designs in real time, refine their aesthetic or functional preferences, and iteratively converge on an optimized version suitable for publication, deployment, or further testing.

As shown in FIG. 1, the updated representation 152B enables the user to interact with multiple webpage components of a candidate webpage. Based on these user interactions, the system may further generate one or more variations of the current webpage (or current candidate webpages) by regenerating, modifying, deselecting, or deleting previously generated content elements within one or more webpage components, changing the selection and arrangement of webpage components, or both.

For example, a user operating the controller device 102 may be presented with a candidate webpage that includes one or more modifications applied to content items from the original webpage. Such modifications may include, for instance, substituting alternative textual or visual content, adjusting layout configurations, reordering sections, altering stylistic attributes (e.g., color schemes or typography), or inserting new webpage components such as promotional banners or media widgets.

The user may select one or more of these modifications to confirm, reject, or refine them further. To support such operations, the updated representation 152B may include a second user interface 164 that allows the user to issue commands instructing the system to modify, regenerate, deselect, or remove specific webpage components or content elements.

Upon receiving the user's modification request, the system processes the request in the backend, leveraging one or more ML models and the CMS 120 (and schema) to generate a new set of candidate webpages. These newly generated webpages may include updated or regenerated content items populated within the designated webpage components. The generated content elements may include, for example, descriptive overviews, product summaries, introductory statements, pricing tables, user testimonials, or other relevant content tailored to the specified webpage sections.

The system enables users to iteratively modify and adjust content items, allowing for continuous refinement of webpage components. Each newly generated or updated content item may serve as a variation that the system uses to populate additional candidate webpages for the user's preview, evaluation, and feedback. This iterative process supports dynamic content evolution, enabling users to progressively optimize one or more webpages according to various design requirements.

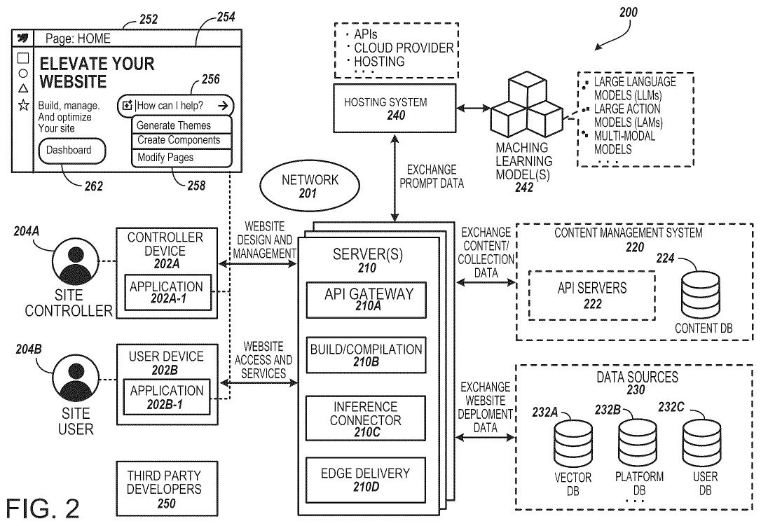

In addition to the controller device 102, one or more server(s) 110, and a CMS 120, the system or platform described herein (e.g., the WEP shown in FIG. 2) includes data sources 130 and a hosting system 140. The hosting system 140 is further communicatively coupled with one or more ML models, deployed on or remote to the hosting system 140. These elements implement backend processes (e.g., information retrieval, information refinement, prompt generation/submission, output processing, and output refinement) relating to user actions on a software frontend and the associated context information.

Referring now to the backend process for generating content items or variation content items used to populate a set of candidate webpages that differ from the current webpage, the one or more servers 110 may initially access content data 116 associated with the current webpage and stored within the content management system (CMS) 120. The content data 116 may include multiple content elements, such as textual descriptions, media assets (e.g., images, videos, or icons), metadata, hyperlinks, and other structured data items associated with the current webpage.

The server(s) 110 may retrieve or access the content data 116 from the CMS 120 through a predefined content schema. The content schema establishes the structural organization of the stored content, defining how multiple content elements relate to each other within the CMS 120. In some implementations, the content schema further specifies the mapping relationships between individual content elements and their corresponding designated webpage components, such as headers, body sections, sidebars, footers, or other suitable webpage components, across one or more webpages.

The content schema may include field definitions, data types (e.g., text, media, relational links), hierarchical structures, and/or inter-component dependencies, as described above. By adhering to this schema, the system ensures consistent data retrieval, efficient schema-based integration, and accurate population of generated variation content items into the appropriate locations of each candidate webpage.

The one or more servers 110 may further identify and retrieve context data 106 associated with the user corresponding to the current webpage. The context data 106 may include user request data 104 received from the controller device 102, which specifies the user's intent to generate one or more new webpages or to modify the content or layout of existing webpages. The user request data 104 may include textual or structured input that defines, for example, target audiences, desired tone or writing style, layout preferences, color palettes, functional specifications for webpage components, or other suitable requirements for webpage generation.

In addition to the user request data, the context data 106 may further include user history data and expert insight data, as described above. The user history data may encompass previously generated webpages, prior modification patterns, user interaction logs, content approval records, metadata describing the user's stylistic and thematic preferences, or other user history data stored in the CMS 120. The expert insight data may include domain-specific guidance, professional design heuristics, accessibility standards, marketing best practices, or other curated datasets developed by experts in webpage design. This information may serve as a set of grounding constraints that improve the relevance, compliance, and overall quality of generated webpages.

Based on the content data 116 presented in the current webpage and the context data 106 retrieved or constructed as described above, the one or more server(s) 110 may generate prompt data 112 to be used as input for one or more ML models 142 coupled to the hosting system 140. The prompt data 112 may include one or more instructions, constraints, or guidance tokens for generating variation content elements derived from the content elements of the current webpage. For example, the prompt data may specify stylistic parameters (e.g., tone, formality, or sentiment), layout instructions (e.g., maintaining a section hierarchy or replacing an image), or performance goals (e.g., increasing readability or engagement rate). The system may also include references to the schema associated with original content items stored in CMS 120, such as field identifiers or content types. This may enable the ML models 142 to generate outputs (e.g., raw output data 114) that conform to the content schema stored in the CMS 120.

In some implementations, prompt data 112 is formulated as a structured or semi-structured input (e.g., JSON, XML, or a natural language prompt) that combines user instructions, contextual embeddings, and previously stored design rules. This structured prompt ensures that the ML models 142 generate coherent, schema-aligned, and semantically relevant variation content elements that may be efficiently integrated into one or more candidate webpages.

The hosting system 140 receives prompt data 112 and executes one or more ML models 142 to generate raw output data 114 in response to the prompt data 112. This raw output data 114 may include various types of content data in accordance with user request data 104 and other context data 106. For example, the raw output data 114 may include visual content such as images, videos, text, or other suitable visual content. The raw output data 114 may include audio content, such as recordings, music, or other suitable audio content. The raw output data 114 may further include interactive or responsive content such as prompts, links, customized recommendations, among others.

The raw output data 114 is returned to the server(s) 110 for further post-processing. During post-processing, the server(s) 110 fuse or adapt the raw output data 114 into the corresponding locations of the webpage components to generate one or more candidate webpages. The fused results are converted into processed output data 108, e.g., candidate webpage data, which is optimized for rendering on the controller device 102. The processed output data 108 includes both the content and the structural instructions necessary to display the candidate webpages with generated content within the next representation 152B of application 152A. Once received and executed by the controller device 102, the processed output data 108 causes the controller device to render the candidate webpages for user interactions, e.g., selecting, modifying, or regenerating webpage content, thereby enabling iterative refinement of the generated webpages as described above.

Moreover, the information retrieval techniques shown in FIG. 1 improve upon RAG-based pipelines involving static vector databases. ML systems that rely on such RAG-based pipelines typically embed free-form documents without regard to application schemas. Similarly, some CMS platforms typically store typed records without generating embeddings that preserve referential constraints or field semantics. In contrast, the techniques shown in FIG. 1 involve generating schema-aware content chunks and corresponding vector representations that explicitly preserve CMS configurations and limitations. Chunk boundaries and embedding metadata are aligned to collection schemas, field types, and cross-reference links (e.g., component IDs, locale variants, or gated fields) so that retrieved content may be injected into prompts and rendered back into the authoring environment without violating referential integrity.

The schema alignment discussed above improves performance in two ways. For instance, it increases retrieval precision by ensuring preference over chunks whose schema tags match the workspace context of application 152A. Further, it reduces post-retrieval repair work because the output data from the ML models 142 is constrained to data models specified by the CMS 120. This is distinct from implementing a standard RAG index with a CMS, which does not involve specific types of chunking and embedding that preserve field-level typing, relationship graphs, and policy constraints.

Moreover, RAG pipelines also tend to produce static indexes (e.g., embeddings computed once and reused until a full rebuild). Similarly, CMS platforms update content continuously without coordinating vector freshness. The system and techniques described within this disclosure address this capacity gap with a recursive, CMS-driven update loop that re-embeds only the affected chunks when schemas, features, or referenced records change, and advances version pointers so retrieval prefers up-to-date vectors.

In some implementations, CMS events (e.g., content publishing, schema editing, feature flag changing) trigger dependency resolution that identifies impacted chunks, recalculates embeddings, and atomically swaps index entries so the vector database reflects the current configuration without a global reindex. This architecture addresses a known limitation of static RAG, which answers that are accurate to their source but outdated or misaligned to a user's current configuration. As shown in FIG. 1, by ensuring that similarity searches are performed over a living corpus whose semantics align with the CMS 120, the resulting benefits include improved contextual relevance and enhanced responsiveness.

The interplay between schema-aware embeddings and the recursive CMS updates also yields various advantages at runtime. For instance, because vectors carry schema and version tags, the server(s) 110 may condition query refinement on the workspace context and select only those chunks whose schema/version signatures match the user's workspace context. This reduces false positives that some RAG systems would surface. Conversely, as the CMS 120 evolves (e.g., a component API changes), update loops ensure the same signatures steer retrieval away from superseded guidance without requiring manual curation. This closed-loop behavior informs how the server(s) 110 orchestrates retrieval and prompting under latency constraints and at multi-tenant scale. This behavior also depends on specific types of data transformations and index maintenance strategies that are specific to typed, evolving application schemas and their operational event streams.

FIG. 2 illustrates an example of a system 200 enabling a web experience platform (WEP) for enabling website development using one or more ML models. In general, the website development capabilities enable users to design digital experiences, ingest user-defined digital experience specifications, transform the user-defined digital experience specifications into deployable artifacts, and distribute resulting web experiences over a network. For example, the WEP may receive design-time input that specifies pages, components, styles, interactions, and content, compile or otherwise process that input (e.g., assistance from one or more ML models) into executable markup, code bundles, media, and metadata. The WEP may store intermediate and final artifacts in multi-tenant data stores, identify a published experience and associated application services to site visitors with edge-based delivery resources. This environment may further support content management, e-commerce, membership gating, localization, extension APIs, among other types of functionality.

In general, system 200 leverages ML within a content-management, schema-constrained WEP to address computer-centric problems in generating, selecting, and rendering webpage modifications at scale. System 200 obtains structured inputs defined by a content schema and associated metadata (e.g., section-level or hierarchy information), constructs constrained prompt data or model inputs from those structures, and applies trained ML models to produce candidate outputs that are validated for structural compatibility before use in the build and delivery pipeline. By grounding ML operations in machine-readable constraints and executing only schema-compatible results, system 200 improves computer operation in distributed web systems (e.g., by reducing integration failures, avoiding incompatible markup, limiting unnecessary network transfers, and enabling low-latency rendering of a single, selected variant on the client device). The WEP further augments and/or improves various aspects of the web development functionality through use of one or more ML models 242. These ML models 242 may be invoked at multiple, independent junctures of WEP workflows to streamline, accelerate, and/or augment tasks that have traditionally needed manual development effort.

For example, a site controller operating the controller device 202A may access an ML interface 256 (e.g., presented as a text-chat, voice, or multimodal panel within the existing design canvas) to submit natural language prompts that cause the one or more ML models 242 to generate entire page layouts, reusable components, helper functions, and the corresponding markup or code artefacts without leaving an authoring environment. After a site has been deployed, other ML interfaces may be used to request automated regeneration or modification of components in a manner that preserves data bindings and collection schemas maintained by a content management system (CMS) 220. This reduces the risk of breaking existing CMS-driven pages.

In another example, a site controller 204A or site user 204B administrator may invoke an ML assistant exposed through a dashboard widget to obtain step-by-step guidance on operational tasks (e.g., configuring localization variants, setting up gated-membership rules, or troubleshooting performance settings) based on conversational queries rather than navigating multiple configuration panels. Each of these interfaces may simply route prompt data to external model resources (e.g., hosting system 240) and returns model output to the same front-end context, the ML functionality may be layered onto different phases of the website-development lifecycle without requiring structural changes to the underlying build, orchestration, or delivery services.

The WEP includes various computing and data elements, examples of which are shown in FIG. 2. These elements generally exchange data over network 201. Controller device 202A represents an authoring endpoint operated by a site controller. User device 202B represents a consumption endpoint operated by a site user. Additional third-party developer devices 250 may interact with extension tooling.

One or more server(s) 210 enable centralized functionality associated with the WEP. These server(s) 210 may correspond to the server 122 shown in FIG. 1. As such, server 122 may perform the functionality described with respect to server(s) 210. Server(s) 210 further include API gateways 210A, orchestration modules 210B, build/compilation modules 210C, inference connector modules 210D, and edge-delivery modules 210E, each of which cooperate to perform request handling, background workflow, artifact generation, machine-learning integration, and content delivery network (CDN)-style dissemination, respectively. CMS 220 encloses API servers 230 and a content database 212B. Further, data sources 230 includes persistent stores, such as vector database 232A, platform database 232B, user DB 232C. A hosting system 240 exchanges prompt data and model output with one or more ML models 242.

In more detail, the site controller 204A may operate a controller device 202A (e.g., desktop computer, laptop, tablet, or similarly capable computing terminal). The controller device 202A executes an authoring application 202A-1 that communicates with WEP over network 201. Using the authoring application 202A-1, the site controller may generate, import, or modify design-time assets (e.g., page structures, component libraries, style sheets, interaction timelines, and data bindings) and submit corresponding save, build, or publish requests to server(s) 210. Controller device 202A may render the authoring application in a browser context, a native container, or another runtime environment, and may exchange design-and-or-maintain website-deployment data with the platform in real time or near-real time.

A site user 204B may operate a user device 202B (e.g., desktop computer, laptop, tablet, smartphone, set-top box) executing a runtime application 202B-1 that requests and renders published site assets delivered by server(s) 210. The user device 202B may load static pages, dynamic CMS-backed content, e-commerce flows, membership-gated resources, or localized variants, depending on how the site was configured by the controller. Interactions initiated from the user device 202B may result in access-and-or-interact website-deployment data being exchanged with server(s) 210, with optional personalization, authentication, or analytics processing performed along the way.

As shown in FIG. 2, the authoring application 202A-1 presents a designer interface 252 that provides access to visual tools enabling a site controller 204A to construct and/or alter a page 254 without direct manipulation of source code. Within interface 252 a component pane may surface reusable elements such as component 262, and a canvas or viewport may preview the evolving layout in real time. An ML interface 256 permits the site controller 204A to issue natural language prompts or other inputs to interact with one or more ML models 242 via hosting system 240. Interface 256 may be implemented in various ways, such as a chat panel, voice overlay, multimodal widget, among others. Responsive model output may drive ML-assisted functions 258, which may include, for example, automatically generating page sections, refactoring existing component 262 for accessibility or localization, producing CMS-compatible schema suggestions, or inserting client-side logic templates. Depending on configuration, similar ML interfaces may also surface within runtime application 202B-1, allowing site users to obtain guided assistance or perform management tasks through conversational interaction.

Server(s) 210 operate as the execution core of WEP, receiving network traffic from external actor devices, coordinating internal workflows, invoking machine-learning resources, and emitting deployable or runtime assets. Although depicted as a single logical block, server(s) 210 may be implemented as a co-located cluster, a distributed micro-service mesh, or a cloud-hosted arrangement that scales elastically with demand.

Further, server(s) 210 incorporate a set of software modules configured to cooperate through message queues, RPC calls, or other service-bus mechanisms. At a high-level API gateway modules 210A handle synchronous ingress. An orchestration tier (not shown in FIG. 2) manages background or long-running tasks. Build/compilation modules 210B convert design input into deployable artifacts. An inference connector layer 210C brokers prompt exchange with the hosting system 240. Edge delivery modules 210D stage static and dynamic resources for low-latency distribution. Each module may be containerized, serverless, or otherwise independently deployable, allowing updates to be rolled out without interrupting the WEP.

API gateway modules 210A perform various functions, such as terminating Transport Layer Security (TLS), validating JavaScript Object Notation (JSON) Web Tokens, and expose Representative State Transfer (REST), Graphical Query Language (GraphQL), or WebSocket interfaces that client applications call when saving designs, fetching CMS content, or running administrative queries. They may apply per-workspace or per-site rate limits, translate external resource identifiers into internal shard keys, and inject correlation metadata into each request for downstream tracing. In zero-trust configurations, the API gateway modules 210A may also perform mutual-TLS handshakes with edge nodes or developer command line interfaces (CLIs) before forwarding traffic onto the internal mesh.

Build/compilation modules 210B retrieve development snapshots, CMS bindings, and theme settings, emit hashed asset bundles, pre-optimized image variants, framework-specific component libraries, and search-index manifests. A dependency graph may be used to identify pages or assets that are invalidated by a change so that a full rebuild is avoided. Unchanged artifacts may also be linked from previous build versions. Output objects are written to a versioned S3-style bucket, tagged with a content hash and build-number metadata, and handed off to edge-delivery modules for global propagation.

Inference connector modules 210C assemble prompt payloads that may include design fragments, content snippets, schema fingerprints, and user-authored questions. The inference connector modules 210C may sign each request with a per-workspace API key, apply temperature or max-token policies set by workspace administrators, and/or dispatch prompts to an external model endpoint over authenticated (e.g., HTTP/2) channels. Inference connector modules 210C also parse received model output into typed actions, such as “generate component,” “rewrite copy,” or “suggest accessibility fix.” These parsed outputs may be queued back to orchestration modules or streamed directly to user devices.

Edge delivery modules 210D take artifacts produced by the build/compilation modules 210B and replicate them across geographically distributed points of presence. Assets may be version-pinned so a canary rollout may serve the new build to a percentage of traffic while the prior build remains active for the remainder. Edge workers may also execute JavaScript or WebAssembly to perform request-time tasks (e.g., cookie-based A/B routing, on-the-fly image resizing, or server-side rendering of personalized fragments before returning a response that is cached for subsequent requests).

The architecture of server(s) 210 enable various applications of ML models 242 in relation to different web development workflows accessible through the WEP. In some implementations, server(s) 210 enable an authoring workflow in which a newly added component is propagated from the design canvas to production in near real-time. For example, when a controller drags a “testimonial” component onto the canvas, the interface 252 emits a JSON delta via WebSocket to API-gateway modules 210A. Orchestration modules enqueue a build job, and the build/compilation modules 210B regenerate only the affected page bundle while reusing shared CSS and runtime libraries. Inference connector modules 210C send the component copy to ML models 242 (e.g., LLM) and requests tone-consistent rewrites. Model output data is streamed back to the interface 252 for user review and approval. The edge delivery modules 210D pre-warm caches for the updated path, enabling publishing to be completed quickly (e.g., under a second).

In some implementations, server(s) 210 enable a live component-refactor workflow that automates accessibility or structural updates across an existing site. A site controller 204A may type “convert nav bars to an accessible drop-down” into ML interface 256. In response, inference connector modules 210C package a prompt containing the site's navigation markup and audit results, retrieve refactored HTML and CSS, and forward the patch to build-and-compilation modules 210B. After incremental compilation, edge-delivery modules 210D push the new build while invalidating only nav-bar assets. A rollback pointer to the previous build is retained for instant reversion if post-publish tests fail.

In some implementations, server(s) 210 enable an administrative guidance workflow that delivers conversational, ML-generated instructions for platform configuration tasks. For example, a site user 204B may interact with a voice widget to ask, “How do I enable multi-language support?” In this example, a voice clip may be transcribed on the user device 202B and posted to API-gateway modules 210A. Inference connector modules 210C query one or more ML models 242 (e.g., knowledge-base-aware model) that returns a checklist of localization steps plus one-click mutation calls. Orchestration modules create a localization workspace, build/compilation modules 210B obtain locale variants, and edge delivery modules 210D begin serving Accept-Language aware routes. This workflow allows the task to be completed without manual navigation through multiple settings screens.

CMS 120 manages structured content that populates pages, components, and dynamic lists served by WEP. The system lets a site controller define collections, fields, and localized variants, stores and surfaces that content so that build and runtime processes may merge it with design artifacts. During ML workflows prompts may be enriched with relevant collection entries or schema information. Model output may be validated against the same schema to ensure that any generated markup stays coordinated with stored data.

CMS 220 further includes API servers 222 and content database 224. The API servers 222 expose read and write endpoints that the design canvas, build pipeline, and runtime site all consume. The content database 224 stores collection items, draft, locale variants, and reference links (e.g., in a multi-tenant partition so that different workspaces remain isolated). These elements of CMS 220 let other modules in WEP (e.g., modules of server(s) 210) treat content as a typed data source rather than raw text.

API servers 222 may implement REST and GraphQL methods for creating collections, uploading media, managing localization, and querying entries at build or request time. Requests enter through API gateway modules 210A and are routed to the appropriate microservice shard. Each call is checked against workspace roles so that only authorized users or processes may insert or mutate content. Server(s) 210 also transmit events that orchestration modules may listen to trigger incremental rebuilds or cache purges.

Content database 224 is a multi-region document store that persists collection schemas, field values, slug indexes, and locale mappings. Each write operation may be versioned, allowing rollback if a site controller 204A accidentally deletes or changes an entry. The content database 224 supports full-text and faceted search so that runtime pages may query on reference fields without loading entire collections. It also stores media metadata that edge delivery modules 210D may use for responsive image selection.

Interaction between API servers 222 and content database 224 may follow a strict commit path. For example, API servers 222 validate incoming payloads against collection schemas, transform the payloads into storage records, and write them to content database 224 in a transaction that ensures referential integrity. When data changes the servers publish a change event to orchestration modules. Build/compilation modules 210B may pull the updated entries, regenerate only the affected pages, and write new artifacts to the build repository. Edge delivery modules 210D receive a signed cache bust instruction so that users see the updated content without delay. This communication loop ensures design, content, and deployment states are aligned even when ML models generate or modify content through the same APIs.

Data sources 230 provide a storage layer that underpins content retrieval, ML context, and runtime personalization for WEP. Databases included in the database sources 230 may sit outside the server(s) 210 so it may scale storage capacity independently of compute demand. For example, read and write operations flow through API gateway 210A or orchestration tasks, and change events propagate to build or edge services so that newly stored records appear in published sites without manual intervention. During prompt generation, the inference connector 210C enriches requests with context fetched from these stores, and after model inference, the same stores are updated or queried to confirm that generated output aligns with existing schemas.

Vector database 232A stores high-dimensional embeddings that represent component code snippets, CMS entries, design tokens, and knowledge base documents. The vector database 232A supports approximate nearest-neighbor search so the inference connector may retrieve semantically similar records in milliseconds. Embeddings are regenerated during build or on demand when a large batch of content changes. The store also tracks embedding versions so model prompts always receive context that matches the active design or content revision.

Platform database 232B holds project metadata such as workspace settings, build history, billing status, feature flags, and role assignments. Each workspace or site occupies a logical partition that isolates records while still allowing cross-workspace queries for administrative analytics. The database maintains foreign keys to build artifacts in object storage and to content items in CMS 220, which lets server modules assemble a complete view of a project without performing fan-out requests.

User database 232C records site member accounts, authentication tokens, membership tiers, and e-commerce order history. Access tokens generated by API gateway 210A map to rows in this store, allowing edge delivery modules 210D to evaluate gating rules during request processing. The user database 232C also captures engagement metrics such as last login time or page view counts, which may feed personalization or analytics dashboards.

The databases discussed above operate together through shared identifiers and event streams to maintain consistency across the platform. When a controller publishes a new collection item the CMS writes the entry to content database 224 and emits an event that triggers embedding generation in vector database 232A. The same event updates index pointers in platform database 232B so build modules may link the updated content to its deployment record. If the item is member-restricted, a policy pointer is stored in user database 232C so edge delivery modules may enforce access at request time. This coordinated flow ensures that ML prompts receive up-to-date context, model output respects schema constraints, and published pages honor all access and personalization rules.

Hosting system 240 provides a managed inference service that receives prompt data from server modules and returns machine-generated output used to augment website design, build, and runtime tasks. The hosting system 240 may allocate compute resources, schedule model workloads, enforce request quotas, and logs usage metrics. Prompt requests may include design fragments, CMS records, or visitor questions. Response payloads may contain generated code snippets, rewritten copy, layout suggestions, or operational guidance that the platform may apply without manual intervention.

Hosting system 240 integrates with the WEP through a set of network accessible endpoints that may be reached by direct API calls, by cloud provider private links, or by a customer managed hosting arrangement. The inference connector 210C authenticates each request with an API key, signs payloads, and posts them to an endpoint path that selects a specific model or model version. The hosting system 240 may reside in a public cloud region, in a dedicated tenancy, or in an on-premise cluster that meets data residency requirements. Configuration flags allow workspace administrators to choose among these connectivity modes without changing application code.

ML models 242 implement the inference logic that generates the information used by the WEP. The models may be LLMs that excel at natural language generation, LAMs that plan multi step tasks, or multimodal (MM) models that accept and emit combinations of text, code, or image embeddings. Each model may be versioned and measured for token usage, latency, and accuracy. The hosting system 240 may route traffic to a single model or to an ensemble of models depending on the prompt type and workspace policy.

ML models 242 operate inside the hosting system 240 in containerized runtimes, e.g., runtimes that that expose uniform gRPC and REST interfaces. The hosting layer may handle model loading, weights decryption, warm-up sequences, and autoscaling. It also injects guardrail middleware that checks prompts for policy compliance and truncates or redacts disallowed content. Model output is streamed back to system 200 in an event format that preserves token order so the authoring canvas may display partial completions in real time.

As discussed above, system 200 may be designed in various implementations to augment, improve, or streamline various aspects of website development using interactions with the one or more ML models 242. For example, a site controller 204A may access interface 252 on controller device 202A and enter a natural language prompt into ML interface 256 asking the platform to “generate a five-page marketing site for a coffee brand with warm colors and bold headings.” Application 202A-1 sends the prompt to API gateway modules 210A over network 201. Inference connector modules 210C forward the prompt to hosting system 240 which relays it to ML models 242. The ML models 242 return structured markup and component definitions that reference images and copy aligned with the request. Build/compilation modules 210B merge the generated markup with schema information pulled from content database 224 through API servers 222 so that every collection reference is valid. Edge delivery modules 210D publish the new artifacts and invalidate only the changed routes which lets user devices 202B immediately load the freshly created pages.

As another example, a site controller 204A may decide to localize the site for Spanish speaking visitors using the same workflow. The site controller 204A issues a prompt in interface 256 that requests translated versions of each collection item stored in content management system 220. API gateway modules 210A receive the prompt along with collection identifiers. Inference connector modules 210C assemble context by fetching the English records and related embeddings from vector database 232A pass that context to ML models 242. The ML models 242 return translated field values which API servers 222 write as new locale variants in content database 224 while platform database 232B records a build dependency for each updated item. Build/compilation modules 210B regenerate only the localized bundles and edge delivery modules 210D tag them with Accept-Language rules so site users automatically receive the correct language version.

In yet another example, during ongoing operation a site user 204B signs in through application 202B-1 and asks an on-page chatbot how to schedule a product launch for next Friday. The question travels through network 201 to API gateway modules 210A and is passed to inference connector modules 210C with user context from user database 232C. ML models 242 analyze the prompt and return a step list that includes creating a draft collection item, assigning a release date, and triggering a publish event. The response also contains signed mutation requests that API servers 222 may execute on behalf of the authenticated user. Orchestration logic writes the new item to content database 224, schedules a timed build in platform database 232B, and notifies build and compilation modules 210B to pre render the page. Edge delivery modules 210D queue a cache purge for the launch path so the updated content appears exactly when the scheduled date arrives.

In some implementations, system 200 is configured to generate adaptive themes that evolve over time based on user behavior and preferences. For example, system 200 may utilize ML models 242 to provide continuous adaptation, which may ensure the long-term relevance and personalization of website themes. In some aspects, the ML models 242 for generating adaptive themes may include user inputs, presets or packs, prebuilt webpage sections, and prompts provided to a machine learning model. System 200 may also be configured to evolve at multiple levels to improve its theme generation capabilities.

For example, the evolution of presets may be based on updated industry trends, the evolution of prompts may be based on user behavior and preferences, or the evolution of an ML model itself may be based on making adjustments to achieve a desired performance. As another example, the evolution of prebuilt webpage sections may be based on adding new sections developed from industry trends or in response to user feedback. In some implementations, system 200 employs a federated learning approach to improve its theme generation capabilities by learning from multiple users while maintaining individual user privacy. System 200 may also generate a continuously evolving and personalized website theme by adapting to user behavior, user feedback, and industry trends, all without the user having to manually update design elements to maintain relevance.

In some implementations, system 200 generates a webpage design in response to one or more inputs provided by a user. For example, the site controller 204A may interact with the controller device 202A to provide an input, such as an image pack or a visual mood board. The controller device 202A may provide the input by selecting from one or more options presented within the designer interface 252. System 200 may determine a theme from the provided input content and provide the determined theme to the one or more models 242.

The one or more ML models 242 may provide a page, or a portion of a page design, as output. System 200 may further allow site controller 204A to review this output and prompt the one or more ML models 242 to iterate on the design, for example, by providing additional input or feedback on the generated page or portion. Accordingly, once the user is satisfied with the generated design, system 200 may provide the page or portion of the page to another system, such as a web development platform, for the webpage or website to be built, without the user having to manually create design specifications or write code, and preserving a feedback-driven workflow.

As described throughout, system 200 may provide a comprehensive ML-driven system for creating, managing, and evolving a complete design system for a website. System 200 may analyze user inputs, brand guidelines, and industry trends to establish core design principles for a website. System 200 may generate a full design system that may include, for example, a typography hierarchy, color palettes, spacing and layout rules, component libraries, and responsive design guidelines, among others. In some aspects, user inputs and brand guidelines may be received through step-by-step intake forms. In other aspects, system 200 may provide presets or packs, such as prebuilt webpage sections, which are built based on influences from industry trends for a user to select. System 200 may generate a complete and coherent design system based on high-level user inputs, without the user having to manually define each design rule or create a component library from scratch, thereby streamlining the brand identity creation process.

In some implementations, system 200 includes one or more key features to perform specific web development tasks. For example, system 200 may utilize a generative adversarial network (GAN)-based module to generate unique visual assets. The visual assets may include, for example, on-brand icons, illustrations, or patterns. As another example, system 200 may provide an ML-style transfer engine that automatically adjusts images to fit the established design system. System 200 may additionally provide an ML-powered design consistency checker to assist in ongoing website maintenance by identifying and flagging inconsistencies. For instance, a user may interact with these features through a natural language interface, which allows non-designers to make informed design adjustments. System 200 may thereby make design generation and maintenance capabilities accessible to a wider range of users, without requiring the user to have specialized design skills or perform manual consistency checks.

In some implementations, system 200 provides an ML-based design consistency checker using one or more ML models 242 to analyze design elements across a generated website. For example, a user may desire to check for design consistency as a web development task. In this example, the ML-based design consistency checker is configured to identify inconsistencies in design elements. The design elements may include, for example, color, typography, spacing, or other design aspects, among others. Upon identifying an inconsistency, system 200 may flag the potential issue and suggest one or more corrections to the user. In this way, system 200 assists in maintaining a cohesive visual identity over time, without the user having to manually inspect webpages for design deviations or possess expert knowledge of the established brand guidelines, thereby preserving the integrity of the design system.

In some implementations, system 200 provides frameworks that ensure consistency, scalability, and brand alignment through continuous evolution of a design system. For example, a user may request to have the design system updated as a web development task. In this example, the design system may evolve based on various data inputs, including user interactions, A/B testing results, and emerging design trends, among others. As another example, design system evolution may further be based on other types of updates (e.g., user inputs, presets/packs, prebuilt webpage sections, ML prompts, ML model updates). In this example, system 200 maintains a relevant and effective design system over time, without requiring a user to manually track and implement changes based on performance data or industry trends, thereby preserving brand alignment in a dynamic environment.

As another example, the continuous evolution of the design system may be based on updates to one or more aspects of system 200. These aspects may include user inputs, presets or packs, prebuilt webpage sections, prompts provided to a machine learning model, or the model itself. System 200 may maintain a relevant and effective design system over time, all without requiring a user to manually track and implement changes based on performance data or industry trends, thereby preserving brand alignment in a dynamic environment. Other methods for the evolution of a design system are also possible.

FIGS. 3A-3D illustrate a sequence of examples of user interfaces 300, 315, 337, and 360 for generating candidate webpages in response to a user request using one or more ML models and a content management system. In this example, the system generates candidate webpages by replacing current content items in a current webpage with variation content elements. The variation content elements may be generated by using one or more ML models that process prompt data grounded by the schema and context data. In some implementations, the variation content elements may be fetched from the CMS based on the context data and the schema.

As shown in FIG. 3A, when a user of the controller device 303 initiates the described techniques for bulk webpage generation, the system may present a first user interface 300. On this interface, the controller device 303 may display a textual introduction section 305 that briefly guides the user through the initial step of changing one or more content elements in a current webpage to generate multiple candidate webpages. For instance, the textual introduction section 305 may display a concise prompt such as “Click an element to make a change.”

As illustrated in FIG. 3A, the first content element (and optionally its designated webpage component(s)) 307 corresponds to one or more headings. A heading generally refers to a textual element that introduces, summarizes, or categorizes the subject matter of a section or subsection within a webpage. Semantically, a heading defines the organizational structure of content and provides a hierarchical anchor for related elements that follow, such as bodies of text or visual media. For example, a heading may include a main title (e.g., “Our Services”), a subheading (e.g., “Custom Web Design Solutions”), or a section label (e.g., “Contact Information”).

The second content element (and optionally its designated webpage component(s)) 309 corresponds to one or more bodies of text. A body of text generally refers to the main textual content that elaborates on or supports a corresponding heading. Semantically, bodies of text exist at a lower level in the hierarchy relative to their associated headings and often provide explanatory, descriptive, or persuasive information. For example, a body of text may include a paragraph describing a company's mission statement, a detailed product description, or an instructional section explaining how to use a service. In some implementations, the semantic relationship between a heading and its corresponding body of text is represented explicitly within the content schema, enabling the CMS to preserve contextual integrity when retrieving or generating related content.

The third content element (and optionally its designated webpage component(s)) 311 corresponds to one or more visual content items. Visual content generally refers to non-textual media, e.g., images, icons, illustrations, videos, or infographics, which may complement or reinforce the meaning of the associated textual content. A visual content element may share the same or a lower semantic hierarchy level than the body of text, depending on its role within the webpage. For instance, a featured image directly supporting a section heading may share the same hierarchy level, whereas an inline graphic embedded within a paragraph may occupy a subordinate level. These semantic hierarchy relationships may be stored and managed within the CMS and may be encoded as part of the content schema.

The first user interface 300 may further include additional content elements and their corresponding designated webpage components, such as hyperlinks, buttons, forms, tables, embedded media players, or other interactive elements. Each of these components may be semantically categorized and structurally represented within the CMS using the same schema framework. Users of the controller device 303 may select one or more of those content elements or webpage components for regeneration or modification according to their different webpage design requirements.

In some implementations, the system provides one or more tools 302 on the sidebar of the first user interface 300. The tools 302 may allow the user to provide materials for modifying or generating content elements. The user materials may include images, text, videos, or other media assets. Additionally, the tools 302 may include an ML-based assistant that provides a chat-based interface to guide users through the design process. This assistant may answer design-related questions, suggest appropriate templates or content chunks, recommend stylistic adjustments, or even propose section arrangements based on the user's expressed goals. By integrating these tools into the sidebar, the system ensures that users have continuous access to supportive functionality across all modes of webpage generation.

After the user selects one or more of the content elements (or their corresponding webpage components) 307, 309, or 311 to generate a set of candidate webpages, the system may cause the controller device 303 to display a second user interface 315 designed to provide additional guidance and interaction options to the user. In some implementations, the second user interface 315 includes a guidance section 325 that dynamically adapts to the user's current workflow or the generation stage of the selected webpage components.

For example, the guidance section 325 may display a concise phrase such as “Let us help you create the first draft” when the selected webpage components or content elements are being generated or modified for the first time. Conversely, if those components or content elements have already been generated or edited in the backend, the guidance section 325 may display a different phrase, such as “Let us help you refine and revise your draft.” This adaptive feedback design helps users understand the context of their current action and provides a smooth, conversational interface that supports both novice and experienced users during webpage creation and revision.

The second user interface 315 may further include a user input box 335 that enables users to enter free-form textual requirements for webpage generation or modification. For instance, a user may specify instructions such as: “Create a landing page for a new mobile app that highlights its key technical features and includes a sign-up form for early access.” The system interprets such free-form input to identify content objectives, target audiences, and structural requirements for webpage generation. In some implementations, the second user interface 315 alternatively (or additionally) collects user requirement data through a guided, step-by-step intake form. This form may include a series of input boxes with contextual prompts or questions, multiple-choice selections for predefined design goals (e.g., “product showcase,” “marketing campaign,” or “event announcement”), or both.

In some implementations, the system supports multi-modal input, enabling users to supplement their textual requests with images, screenshots, videos, audio clips, or other suitable multimodal media. For example, a restaurant owner could upload menu photos and a short promotional video to generate multiple webpages for the restaurant. As another example, a photographer might upload sample images to guide the design of their portfolio site. The system may also allow the user to specify structural constraints, such as the desired number of candidate webpages (e.g., “generate three versions of a landing page”) or the number of sections per page (e.g., “limit each page to four sections, including a testimonial section”). These flexible inputs enable the system to accommodate a wide range of user design preferences and functional requirements.

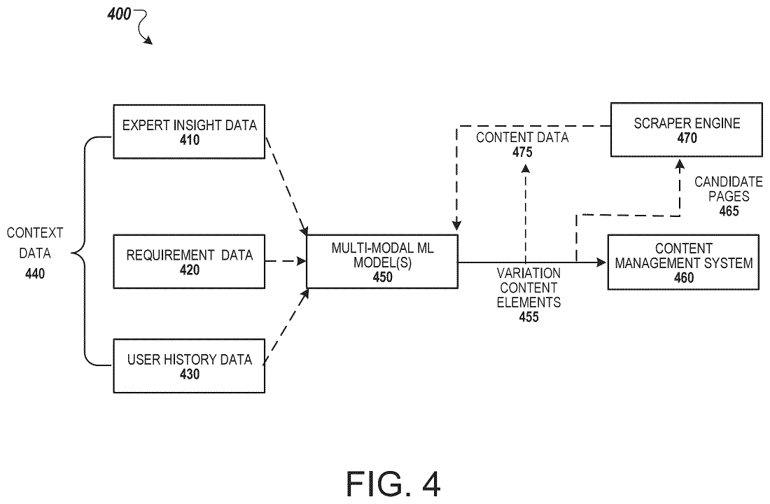

Once the user completes the input and activates the “Generate” button 333, the system aggregates the collected inputs into user request data. User request data is transmitted to the backend server(s) for processing. The backend server(s) construct prompt data for ML models to generate variation content items based on the user request data, content schema from the CMS, and additional context data, such as user history data and expert insight data, as described above. More details of the backend processing using ML models and corresponding prompt data generation are described below in connection with FIG. 4.

The one or more ML models may include multimodal ML models that are capable of processing prompt data combining multiple types of inputs (e.g., text, images, audio, and structured metadata). A typical multimodal ML model architecture may include a multimodal encoder that projects heterogeneous inputs into a shared latent space and a multimodal decoder that generates coherent outputs aligned with webpage requirements. For example, such a model might take as input textual user requests, uploaded images, and context metadata, and output a webpage section containing formatted text paired with relevant images or other visual content. In some implementations, the ML models include LLMs to generate natural language text and/or LAMs to predict and orchestrate structural or layout-related actions in webpage design.

The one or more servers obtain output data from the ML models based on the constructed prompt data and use that output to instantiate multiple candidate webpages for user review and iterative refinement. The number of candidate webpages to be generated may be specified by the user as part of the user request data, allowing flexible control over the breadth of webpage variations presented.

As illustrated in FIG. 3C, the controller device 303 may display a third user interface 337 that presents visual representations of one or more candidate webpages populated with variation content elements produced during backend processing. For example, the third user interface 337 may display a first candidate webpage featuring content elements that differ from those in the original webpage displayed in the first user interface 300. These variation content elements may include one or more updated headings 347, updated bodies of text 349, and/or updated visual content items 351, each generated to satisfy the user's specified requirements or stylistic preferences (or context data) and schema.

In some implementations, the candidate webpage displayed in the third user interface 337 further include additional or alternative webpage components populated with newly generated content derived from the user request data (or context data) and content schema. For example, the third user interface 337 may present a new webpage component containing a new body of text 345 (e.g., a new introductory summary) or a new visual content element 353 (e.g., a banner image). The system may dynamically determine the necessity of adding new webpage components based on semantic relationships, schema definitions, or model inferences. In some implementations, the user specifies requirements for adding new webpage components and generating new content by interacting with the first user interface 300 and/or second user interface 315.

As a more concrete example and with reference to FIG. 3C, a user may request the system to “redesign the product landing page to emphasize sustainability and eco-friendly features.” In response, the system may generate multiple candidate webpages that include updated headings such as “Engineered for a Greener Future” 347, revised body text 349 highlighting recyclable materials and energy-efficient production methods, and new visual content 351 showing eco-themed imagery (e.g., nature backgrounds or product lifecycle graphics). In some versions, the system may also introduce a new webpage component 353, such as an interactive “Sustainability Report” section, automatically populated with generated summaries and icons reflecting the brand's environmental commitments.

In some implementations, the system displays one of the generated candidate webpages, accompanied by one or more user-interactive features that enable the user to further modify, refine, or optimize the displayed candidate webpage. For example, as shown in FIG. 3D, the controller device 303 may present a fourth user interface 360 including a left section and a right section.

In the left section, the fourth user interface 360 displays a selected candidate webpage containing one or more variation content elements generated through backend processing. Specifically, the interface may include a title section 365 with a first variation content element, such as the heading “Webflow Offers Free Plans for College Students.” Adjacent to the title section, a body of text section 367 provides explanatory content describing the free plans available to students and their eligibility requirements. Beneath the body of text, two hyperlinks (369 and 371) may be displayed (e.g., one directing new students to a registration page and the other directing educators to a login or verification portal).

The fourth user interface 360 may further include additional visual content components within the displayed candidate webpage. For instance, a first webpage component 373 may present the webpage logo, a second webpage component 375 may display a supporting image or graphic related to the title section, and a third webpage component 377 may render an icon, badge, or symbol reinforcing the overall visual design. These coordinated visual and textual elements together form a cohesive candidate webpage layout that the user may interact with and refine.

The right section of the fourth user interface 360 may provide one or more interactive features that allow users to selectively modify, regenerate, or fine-tune variation content elements and/or webpage components. For example, the interface may include a guidance interface 381 configured to provide step-by-step assistance during modification or regeneration of ML-generated content. The guidance interface 381 may prompt the user to select a specific content item for revision and, upon selection, display a contextual message such as “Let's rewrite this for you.” The user may enter specific regeneration instructions, editing guidelines, or replacement text within an input text box 383. In some implementations, the user directly edits or overwrites the selected content in the text box, providing granular control over the final output. Upon clicking the regenerate button 385, the controller device 303 transmits the new user request data to the backend server(s) for processing. The system regenerates the specified content item or webpage component based on the updated user input, seamlessly refreshing the displayed candidate webpage.

The fourth user interface 360 may also include a dropdown menu 387 that allows users to select or deselect webpage components and/or variation content items currently populated in designated components of the candidate webpage. The dropdown menu 387 may include a brief guidance message such as “Deselect anything you don't like” and list the available webpage components and their associated variation content elements 391 for user review.

In some implementations, variation content items are selected by default. When a user deselects one or more content elements or components, the corresponding sections are hidden or visually deactivated in the displayed candidate webpage within the left section. The system may further interpret the user's deselection as a backend regeneration request and transmit it to the server(s) for automatic generation of alternative variation content elements or updated candidate webpages.

The example interfaces shown in FIGS. 3A-3D are presented for simplicity and clarity. Other arrangements, variations, and combinations of these interfaces are possible, including additional customization panels, multi-step wizards, or adaptive interfaces that dynamically adjust based on the user's design proficiency.

In some implementations, the system further determines design options as context data based on aggregated user preferences collected across multiple controller devices. The system may receive preference data indicating template or style selections from multiple users, and the server may generate aggregate preference profiles based on this data. These aggregate profiles may be used to update content variations for generating candidate webpages. This technique enables the system to tailor outputs based on aggregated user preference trends while preserving the privacy of individual users.

FIG. 4 illustrates an example of a process 400 for generating content data using one or more ML models. For example, the hosting system 140 of FIG. 1, and optionally the server(s) 110 of FIG. 1, when properly coordinated, may perform operations presented in process 400.

More specifically, the system may deploy one or more ML models to generate variation content elements for creating one or more candidate webpages. The ML models may include, for example, a multimodal ML model 450 including a multimodal encoder and a multimodal decoder, as described above. The system generates prompt data, which generally encompasses contextual and content information related to the current webpage, to serve as input for the ML models. The ML models process the prompt data to produce variation content elements that may replace or supplement the original content on the current webpage for generating multiple distinct candidate webpages.

As described above, the system may collect context data 440 from the user interface of a controller device or from the CMS 460. This context data 440 generally provides grounding information to produce outputs that are contextually relevant and semantically coherent with the existing webpage and the user's requirements.

The context data 440 may include multiple sources of information, such as expert insight data 410, requirement data 420, and user history data 430. For example, the expert insight data 410 may include best practices, design heuristics, or stylistic guidelines curated by domain experts. For example, the expert insight data 410 may include recommendations on visual hierarchy, content tone, accessibility compliance, and brand consistency. The requirement data 420 relates to user-specified parameters received through the user interface, which may include target audience, layout preferences, tone of writing, or content length. The user history data 430 generally relates to historical information related to users' actions when designing webpage components and content items, as well as user-specific data stored in the CMS 460, or other historical data associated with the user. The user history data 430 may include previously generated webpages, prior modification logs, and user interaction data, as described above. Collectively, the context data 440 generally provides contextual signals that the system uses to guide content generation using ML models, ensuring that candidate webpages with newly generated content items align with both technical constraints and user preferences.

In addition to the context data, the system may collect content data 475 corresponding to the content currently presented on the webpage. The content data 475 may include multiple content elements representing textual, visual, and interactive components of the webpage. For example, the textual content may include titles, paragraphs, captions, or call-to-action statements arranged at different abstraction or semantic hierarchy levels. The visual content may include images, graphics, icons, videos, or other multimedia elements displayed within webpage components. The content elements may also include one or more hyperlinks associated with either textual or visual content. These hyperlinks may be explicitly defined in the content schema stored in the CMS 460, allowing the system to preserve relational mappings between elements during webpage generation and variation.

In some implementations, the system includes a scraper engine 470 configured to extract or read content data 475 presented on the current webpage. In general, the scraper engine 470 identifies, classifies, and retrieves webpage components and their associated content elements in real time. For example, the scraper engine 470 may include one or more modules for parsing webpage markup, detecting semantic structures (e.g., headings, body sections, or embedded media), and generating metadata that maps each content element to its corresponding schema entry in the CMS 460. The scraper engine may also generate vectorized representations of the extracted data to facilitate downstream ML processing and similarity-based retrieval.

The system may generate prompt data for the ML models 450 based on both the context data 440 and the content data 475. The dashed lines connecting context data 440 and content data 475 to the ML models 450 (as shown in FIG. 4) indicate that these datasets are not provided directly as raw ML model input. Instead, the system constructs and refines prompt data that integrates salient features from both context data 440 and content data 475 to ensure that the ML models generate content that is contextually aligned and structurally compatible with the target webpage.

The ML models 450 process the generated prompt data to produce variation content elements 455, which are populated into designated webpage components to form multiple candidate webpages. The variation content elements 455 may inherit schema attributes from the content schema used by the CMS 460, preserving predefined relationships, metadata associations, and hyperlink structures. This schema inheritance ensures that generated content remains compatible with the CMS framework and may be efficiently integrated, retrieved, or replaced.

The CMS 460 may receive and store the variation content elements 455. In some implementations, the CMS 460 stores newly generated variation content elements in new memory addresses separate from those used by the original webpage content. Alternatively, the CMS 460 may overwrite the original memory addresses with the new variation content elements, depending on user configuration or schema rules. In some cases, the CMS 460 may perform partial updates, storing only the portions of variation content that differ from the original content. This approach minimizes memory bandwidth usage and computational overhead. Furthermore, when a user selects a preferred candidate webpage through the controller device, the CMS 460 may automatically update the corresponding memory addresses to store the chosen variation content elements.

The system may substitute one or more variation content elements 455 for the original content elements represented in designated webpage components of the current webpage to generate candidate webpage data. The system may generate one or more instructions based on the candidate webpage data, that, when transmitted to and executed by the controller device, cause the controller device to render one or more candidate webpages 465 for user interaction and feedback. In some implementations, the scraper engine 470 may periodically extract variation content elements from the displayed candidate webpages 465 to refresh the content data 475. This updated content data may be used to construct new prompt data for subsequent ML model operations. As a result, the system continuously refines its understanding of users' webpage design preferences and content structure, enabling iterative regeneration of variation content elements and maintaining an adaptive feedback loop for ongoing improvement in webpage generation quality and efficiency. For enhanced efficiency, the system may directly infuse newly generated variation content elements 455 into content data 475 for a subsequent round of content generation using ML models 450, without having the scraper engine 470 fetch the variation content elements 455 through the new candidate webpages.

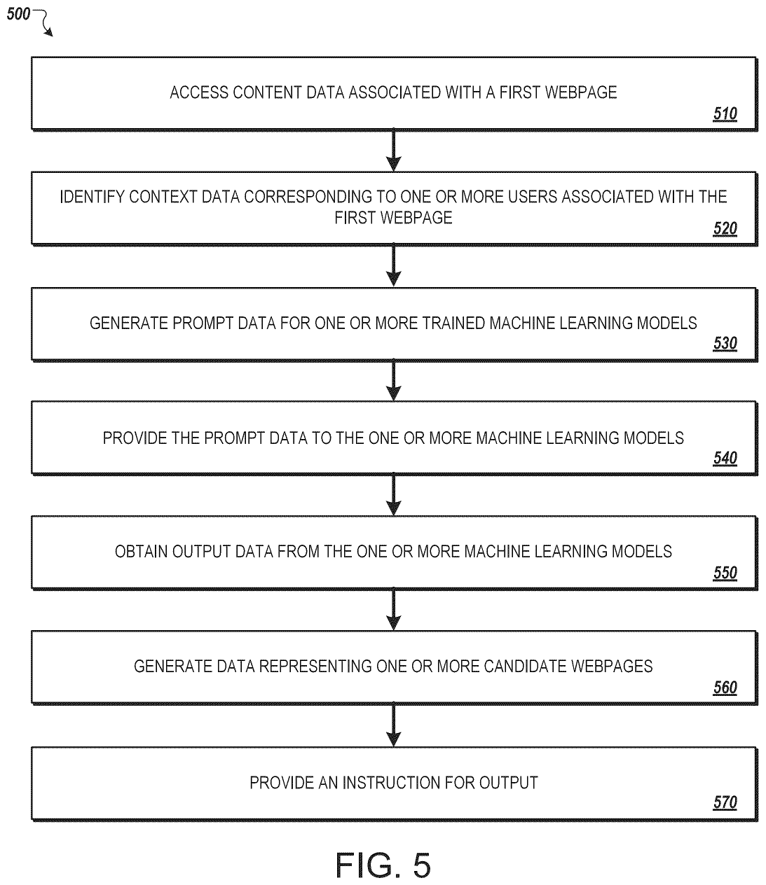

FIG. 5 illustrates a flow chart for an example of a process 500 for generating candidate webpages in response to a user request using one or more ML models and a content management system. The operations of the example process 500 may be performed by one or more systems, e.g., system 200 of FIG. 2 or one or more elements of system 200. Process 500 may be executed by system 200 further in relation to the technique shown in FIG. 1. Server(s) 110 may collect and process content data from a current webpage and context data associated with the user's preference to generate prompt data. The prompt data is provided as input to one or more ML models, which generate variation content elements to substitute for corresponding content elements on the current webpage, thereby creating multiple candidate webpages.

Process 500 includes accessing content data associated with a first webpage (510). Content data may include multiple content elements that collectively define the structure and presentation of the first webpage. In some implementations, the first webpage corresponds to a current webpage that the user is editing or viewing through the controller device within the system. The content elements may include, for example, textual components (e.g., titles, paragraphs, or captions), visual components (e.g., images, icons, or videos), and interactive elements (e.g., hyperlinks, buttons, or forms), as described above. The content data may be retrieved and accessed from a CMS according to a predefined content schema. The content schema defines the structural organization and logical relationships between the plurality of content elements, including mappings between webpage components, metadata fields, and relational dependencies, as described above.

The content elements of the first webpage may include textual content organized at different abstraction or semantic hierarchy levels, visual content defining the graphical layout and aesthetic presentation of the webpage, and hyperlinks that establish navigational or referential connections between textual and/or visual content.

For example, the textual content may include a main heading that introduces a topic, subheadings that organize related information, and body text providing descriptive or persuasive details. The visual content may include a banner image, product illustrations, embedded videos, or graphical icons that complement textual information. The hyperlinks may connect users to related webpages, registration forms, or external references.

In some implementations, the system obtains the content data by deploying a scraper engine configured to identify, extract, and classify content elements presented on the first webpage. In general, the scraper engine serves as a software component that programmatically reads a webpage and retrieves textual, visual, and interactive elements for analysis and integration into the CMS. The scraper engine may further generate metadata describing the relationships, hierarchy levels, and component boundaries of the extracted content elements. Additional details regarding the scraper engine are described above.

Process 500 includes identifying context data corresponding to one or more users associated with the first webpage (520). The context data may include one or more of user requirement data, user history data, or expert insight data, which collectively provide the system with contextual grounding for webpage generation and modification.

As described above, the user requirement data may include information explicitly provided by the user, such as desired webpage structure, stylistic preferences, functional specifications, or content themes. The user history data may include prior webpage versions, historical edit logs, usage patterns, engagement metrics, or previous generation requests made by the same user or account. The expert insight data may include domain-specific design guidelines, marketing heuristics, accessibility standards, or editorial best practices curated by experts to ensure that the generated content aligns with quality, brand, and compliance objectives.

In some implementations, the user requirement data includes textual input entered by a user of the controller device into an application or user interface associated with the first webpage. For example, the user may type a free-form instruction such as “Generate a landing page highlighting our new product line with a modern layout and concise feature descriptions.” Alternatively, the user may complete a structured intake form specifying attributes such as target audience, color scheme, tone of writing, and desired page length.

Process 500 includes generating prompt data for one or more trained ML models based on the content data and the context data (530). The prompt data may include one or more instructions for generating one or more variation content elements based on the content elements, as described above. These variation content elements may include, for example, updated headings, rewritten bodies of text, alternative visual assets, or modified hyperlinks, as described above.

Process 500 includes providing prompt data to the one or more trained ML models (540). The ML models process the prompt data to generate variation content elements based on the contextual and structural information encoded therein.

In some implementations, the one or more trained ML models include a multimodal ML model configured to process and integrate inputs of different modalities, such as text, images, and structured metadata, to produce coherent and contextually aligned outputs. Additionally, or alternatively, the one or more trained ML models may include an LLM trained on extensive text corpora to generate, refine, or rewrite textual content in accordance with the user's specified requirements, stylistic preferences, and contextual constraints.

Process 500 includes obtaining output data corresponding to the one or more variation content elements (550). The output data may include text, images, layout suggestions, or other multimodal content generated in response to the prompt data, as described above.

Process 500 includes generating data representing the one or more candidate webpages by adapting the one or more variation content elements according to the predefined content schema (560). As described above, the predefined content schema specifies how different content elements correspond to webpage components and governs their organization, hierarchy, and relational structure.

Generating data representing the one or more candidate webpages may include replacing one or more content elements specified in the first webpage with corresponding variation content elements produced by the ML models. For example, the system may generate a first candidate webpage by substituting the original heading and body text of a section with updated textual variations reflecting a new tone, branding style, or informational emphasis. As another example, the system may generate a second candidate webpage by replacing one or more visual content elements (e.g., images, icons) with newly generated or selected visual assets while retaining the original textual structure.

In some implementations, different candidate webpages include distinct combinations of substituted content elements and/or webpage components, enabling diverse variations for user review and testing. The system may also automatically select, reorder, or rearrange webpage components according to user requests, schema, and/or context data. This way, the system may augment generation of candidate webpages to facilitate the user to explore alternative layouts, visual hierarchies, or design strategies.

Process 500 includes providing an instruction for output (570). For example, when received and executed by the computing device, the instruction generally causes the computing device to display a representation of at least one candidate webpage included in the one or more candidate webpages.

In some implementations, the system further enables the user to iteratively adjust one or more variation content elements displayed within a candidate webpage. Through an interactive user interface, the user may modify, regenerate, or refine specific portions of the candidate webpage, such as headings, body text, images, or hyperlinks. Each user adjustment may trigger an incremental update cycle in which the system regenerates or reconfigures affected components and instantiates new candidate webpages while preserving the overall structure of the candidate webpage, as described above.

In some implementations, the system receives, from the computing device, user input data indicating the selection of a particular candidate webpage from among the one or more candidate webpages presented for review. In response to receiving this selection input, the system adjusts a configuration associated with the selected candidate webpage within the CMS based on one or more variation content elements corresponding to that webpage.

As described above, the CMS may automatically update internal schema mappings, component associations, and/or version identifiers to reflect the user's chosen variation while maintaining consistency with other stored webpage configurations. This ensures that the selected candidate webpage and its associated variation content elements are properly integrated, stored, and retrievable within the CMS for subsequent processing and iteration.

In some implementations, the system receives data indicating a user modification to the representation of at least one candidate webpage. In response, the server system may generate, based on the detected user modification, second prompt data for the one or more ML models. The second prompt data may include one or more instructions for generating additional variation content elements that incorporate or reflect the user's modification. For example, the modification may include further editing or replacing textual content (e.g., revising a heading or paragraph), altering visual elements (e.g., substituting an image or adjusting layout dimensions), adding or removing hyperlinks, or rearranging webpage components to achieve a different visual hierarchy or user experience, as described above.

The system may provide the second prompt data to the one or more trained ML models and obtain, from the ML models, second output data corresponding to the additional variation content elements. Based on the second output data, the server system may generate data representing one or more updated candidate webpages by adapting the additional variation content elements according to the predefined content schema. The generation of further candidate webpages is similar to the generation of the first set of candidate webpages described above.

Finally, the system may transmit, to the computing device, a second instruction that, when received and executed by the computing device, causes the device to display a second representation of at least one of the updated candidate webpages. This process enables an iterative feedback loop through which user modifications are continuously integrated into the webpage generation workflow, allowing the system to refine and present updated webpage variations in real time.

This specification uses the term “configured” in connection with systems and computer program components. For a system of one or more computers to be configured to perform operations or actions means that the system has installed thereon software, firmware, hardware, or a combination thereof that, in operation, cause the system to perform the operations or actions. For one or more computer programs to be configured to perform operations or actions means that one or more programs include instructions that, when executed by data processing apparatus, cause the apparatus to perform the operations or actions.

Implementations of the subject matter and the functional operations described in this specification may be realized in digital electronic circuitry, in tangibly-implemented computer software or firmware, in computer hardware, including the structures disclosed in this specification and their structural equivalents, or in combinations of one or more of them. Implementations of the subject matter described in this specification may be implemented as one or more computer programs (e.g., one or more modules of computer program instructions) encoded on a tangible non-transitory storage medium for execution by, or to control the operation of, data processing apparatus. The computer storage medium may be a machine-readable storage device, a machine-readable storage substrate, a random or serial access memory device, or a combination of one or more of them. The program instructions may be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus may also be, or further include special purpose logic circuitry (e.g., an FPGA (field programmable gate array) or an ASIC (application-specific integrated circuit)). The apparatus may optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, may be written in any form of programming language, including compiled or interpreted languages, or declarative or procedural languages; and it may be deployed in any form, including as a stand-alone program or as a module, component, subroutine, or other unit suitable for use in a computing environment. A program may, but need not, correspond to a file in a file system. A program may be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines may be installed and running on the same computer or computers.

The processes and logic flows described in this specification may be performed by one or more programmable computers executing one or more computer programs to perform functions by operating on input data and generating output. The processes and logic flows may also be performed by special purpose logic circuitry (e.g., an FPGA, an ASIC), or by a combination of special purpose logic circuitry and one or more programmed computers.

Computers suitable for the execution of a computer program may be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory may be supplemented by, or incorporated in, special purpose logic circuitry. Generally, a computer will also include or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media, and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification may be provisioned on a computer having a display device (e.g., a CRT (cathode ray tube) or LCD (liquid crystal display) monitor) for displaying information to the user and a keyboard and a pointing device (e.g., a mouse, a trackball), by which the user may provide input to the computer. Other kinds of devices may be used to provide for interaction with a user as well; for example, feedback provided to the user may be any form of sensory feedback (e.g., visual feedback, auditory feedback, tactile feedback); and input from the user may be received in any form, including acoustic, speech, or tactile input. In addition, a computer may interact with a user by sending documents to and receiving documents from a device that is used by the user; for example, by sending web pages to a web browser on a user's device in response to requests received from the web browser. Also, a computer may interact with a user by sending text messages or other forms of message to a personal device (e.g., a smartphone that is running a messaging application) and receiving responsive messages from the user in return.

Data processing apparatus for implementing ML models may also include, for example, special-purpose hardware accelerator units for processing common and compute-intensive parts of ML training or production (e.g., inference, workloads).

ML models may be implemented and deployed using an ML framework (e.g., a TensorFlow framework, a Microsoft Cognitive Toolkit framework, an Apache Singa framework, and an Apache MXNet framework).

Implementations of the subject matter described in this specification may be realized in a computing system that includes a back-end component (e.g., as a data server) a middleware component (e.g., an application server), and/or a front-end component (e.g., a client computer having a graphical user interface, a web browser, or an app through which a user may interact with implementations of the subject matter described in this specification), or any combination of one or more such back-end, middleware, or front-end components. The components of the system may be interconnected by any form or medium of digital data communication (e.g., a communication network). Examples of communication networks include a local area network (LAN) and a wide area network (WAN) (e.g., the Internet).

The computing system may include clients and servers. A client and server are generally remote from each other and typically interact through a communication network. The relationship between client and server arises by virtue of computer programs running on the respective computers and having a client-server relationship with each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) may be received at the server from the device.

While this specification contains many specific implementation details, these should not be construed as limitations on the scope of any invention or on the scope of what may be claimed, but rather as descriptions of features that may be specific to implementations of particular inventions. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially be claimed as such, one or more features from a claimed combination may in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems may generally be integrated together in a single software product or packaged into multiple software products.

Particular implementations of the subject matter have been described. Other implementations are within the scope of the following claims. For example, the actions recited in the claims may be performed in a different order and still achieve desirable results. As one example, the processes depicted in the accompanying figures do not necessarily require the particular order shown, or sequential order, to achieve desirable results. In some cases, multitasking and parallel processing may be advantageous.

A number of implementations have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
accessing, by a server system and from a computing device, content data associated with a first webpage, wherein the content data (i) comprises a plurality of content elements and (ii) is accessed from a content management system according to a predefined content schema defining relationships between the plurality of content elements;
identifying, by the server system, context data corresponding to one or more users associated with the first webpage;
generating, by the server system and based on (i) the content data and (ii) the context data, prompt data for one or more trained machine learning (ML) models, wherein the prompt data comprises one or more instructions for generating one or more variation content elements based on the plurality of content elements;
providing, by the server system, the prompt data to the one or more trained ML models;
obtaining, by the server system and from the one or more trained ML models, output data corresponding to the one or more variation content elements;
generating, by the server system, data representing the one or more candidate webpages by adapting the one or more variation content elements according to the predefined content schema; and
providing, by the server system and to the computing device, an instruction that, when received by the computing device, causes the computing device to display a representation of at least one candidate webpage included in the one or more candidate webpages.

2. The method of claim 1, wherein the context data comprises one or more of user requirement data, user history data, or expert insight data.

3. The method of claim 2, wherein the user requirement data comprises a textual input by a user of the computing device into an application displayed on the first webpage.

4. The method of claim 1, wherein the plurality of content elements comprises:
textual content at respective abstraction levels of the first webpage;
visual content of the first webpage; and
one or more hyperlinks associated with the textual content or the visual content.

5. The method of claim 1, wherein generating data representing the one or more candidate webpages comprises replacing a content element specified in the first webpage with a corresponding variation content element.

6. The method of claim 1, wherein the one or more trained ML models comprise a multi-modal ML model.

7. The method of claim 1, wherein the one or more trained ML models comprise a large language model (LLM).

8. The method of claim 1, further comprising:
receiving, by the server system and from the computing device, user input data indicating selection of a particular candidate webpage from among the one or more candidate webpages; and
in response to receiving the user input data, adjusting a configuration associated with the candidate webpage within the content management system based on one or more variation content elements corresponding to the particular candidate webpage.

9. The method of claim 1, further comprising:
receiving, by the server system, data indicating a user modification to the representation of the at least one candidate webpage;
generating, by the server system and based on the user modification, second prompt data for the one or more trained ML models, wherein the second prompt data comprises one or more instructions for generating one or more additional variation content elements based on the user modification;
providing, by the server system, the second prompt data to the one or more trained ML models;
obtaining, by the server system and from the one or more trained ML models, second output data corresponding to one or more additional variation content elements;
generating, by the server system, data representing one or more updated candidate webpages by adapting the one or more additional variation content elements according to the predefined content schema; and
providing, by the server system and to the computing device, a second instruction that, when received by the computing device, causes the computing device to display a second representation of at least one of the one or more updated candidate webpages.

10. A system comprising one or more computers and one or more storage devices storing instructions that, when executed by one or more computers, cause the one or more computers to perform respective operations, the operations comprising:
accessing, by a server system and from a computing device, content data associated with a first webpage, wherein the content data (i) comprises a plurality of content elements and (ii) is accessed from a content management system according to a predefined content schema defining relationships between the plurality of content elements;
identifying, by the server system, context data corresponding to one or more users associated with the first webpage;
generating, by the server system and based on (i) the content data and (ii) the context data, prompt data for one or more trained machine learning (ML) models, wherein the prompt data comprises one or more instructions for generating one or more variation content elements based on the plurality of content elements;
providing, by the server system, the prompt data to the one or more trained ML models;
obtaining, by the server system and from the one or more trained ML models, output data corresponding to the one or more variation content elements;
generating, by the server system, data representing the one or more candidate webpages by adapting the one or more variation content elements according to the predefined content schema; and
providing, by the server system and to the computing device, an instruction that, when received by the computing device, causes the computing device to display a representation of at least one candidate webpage included in the one or more candidate webpages.

11. The system of claim 10, wherein the context data comprises one or more of user requirement data, user history data, or expert insight data.

12. The system of claim 11, wherein the user requirement data comprises a textual input by a user of the computing device into an application displayed on the first webpage.

13. The system of claim 10, wherein the plurality of content elements comprises:
textual content at respective abstraction levels of the first webpage;
visual content of the first webpage; and
one or more hyperlinks associated with the textual content or the visual content.

14. The system of claim 10, wherein generating data representing the one or more candidate webpages comprises replacing a content element specified in the first webpage with a corresponding variation content element.

15. The system of claim 10, further comprising:
receiving, by the server system and from the computing device, user input data indicating selection of a particular candidate webpage from among the one or more candidate webpages; and
in response to receiving the user input data, adjusting a configuration associated with the candidate webpage within the content management system based on one or more variation content elements corresponding to the particular candidate webpage.

16. One or more computer-readable storage media storing instructions that, when executed by one or more computers, cause the one or more computers to perform respective operations, the respective operations comprising:
accessing, by a server system and from a computing device, content data associated with a first webpage, wherein the content data (i) comprises a plurality of content elements and (ii) is accessed from a content management system according to a predefined content schema defining relationships between the plurality of content elements;
identifying, by the server system, context data corresponding to one or more users associated with the first webpage;
generating, by the server system and based on (i) the content data and (ii) the context data, prompt data for one or more trained machine learning (ML) models, wherein the prompt data comprises one or more instructions for generating one or more variation content elements based on the plurality of content elements;
providing, by the server system, the prompt data to the one or more trained ML models;
obtaining, by the server system and from the one or more trained ML models, output data corresponding to the one or more variation content elements;
generating, by the server system, data representing the one or more candidate webpages by adapting the one or more variation content elements according to the predefined content schema; and
providing, by the server system and to the computing device, an instruction that, when received by the computing device, causes the computing device to display a representation of at least one candidate webpage included in the one or more candidate webpages.

17. The one or more computer-readable storage media of claim 16, wherein the context data comprises one or more of user requirement data, user history data, or expert insight data.

18. The one or more computer-readable storage media of claim 17, wherein the user requirement data comprises a textual input by a user of the computing device into an application displayed on the first webpage.

19. The one or more computer-readable storage media of claim 16, wherein the plurality of content elements comprises:
textual content at respective abstraction levels of the first webpage;
visual content of the first webpage; and
one or more hyperlinks associated with the textual content or the visual content.

20. The one or more computer-readable storage media of claim 16, wherein generating data representing the one or more candidate webpages comprises replacing a content element specified in the first webpage with a corresponding variation content element.
